(19) United States
(12) Patent Application Publication
(10) Pub. No.: US 2017/0004221 A1
(43) Pub. Date: Jan. 5, 2017

(54) ESTABLISHMENT OF STATE REPRESENTATION OF A WEB PAGE REPRESENTED IN A WEB BROWSER

(71) Applicant: Kapow Technologies, Horsholm (DK)

(72) Inventor: Morten Sylvest Olsen, Copenhagen (DK)

(21) Appl. No.: 15/112,680

(22) PCT Filed: Oct. 31, 2014
(86) PCT No.: PCT/EP2014/073434

§ 371 Date: Jul. 19, 2016

(30) Foreign Application Priority Data
Nov. 1, 2013 (DK) PA 2013-70640

(51) Int. Cl. G06F 17/30

(52) U.S. Cl. CPC G06F 17/30896; G06F 17/30905

(57) ABSTRACT

The presently disclosed inventive concepts relate to establishing a state representation of a web page represented in a web browser. This concept includes processing a web page retrieved from a web based data source; establishing a resulting first internal browser state representation of the web page; establishing an external representation representing a state of the first internal representation; establishing a representation of a first content of the first internal browser state representation; establishing a dynamic content state representation which represents the state of the dynamic content of the first internal browser state representation; establishing mapping data comprising relationships between the dynamic content and the first content; and making the external representation available to a web browser application so as to establish a further internal representation of the web page in the web browser application at a state corresponding to the state of the first internal browser state representation.

### FIELD OF THE INVENTION

The presently disclosed inventive concepts relate to methods, systems, and computer program products configured to establish a state representation of a web page represented in a web browser, a system for establishing external representations of a first internal browser state representation of a web browser and establishing a further internal representation based thereon, a web browser and a method of browsing web based data sources.

### BACKGROUND ART

The content and fundamental construction of web pages has developed during the recent years. Hence, a significant part of web pages are dynamic web pages comprising dynamic content ouch on scripting content together with markup language content and other contents. The scripting content of web pages facilitates establishment of intuitive and multi-functional web pages, and web pages that automatically adapts to user input during browsing of the web page.

As a result of this, the dynamic web pages, when processed by a web browser, may result in individual representations of the web page in the different web browsers based on e.g. user actions, the location of the web browser, the scripting content itself and so on. This however results in a problem in relation to determining the resulting representation of a dynamic web page in the web browser.

The presently disclosed inventive concepts, among others, provide a solution to the above mentioned issues.

### SUMMARY

The presently disclosed inventive concepts encompass systems, method, computer program products, and the like which are configured to facilitate establishing a state representation of a web page represented in a web browser. In various embodiments, these concepts include the following.

In one approach, a method of establishing a state representation of a web page represented in a web browser includes performing the following operations using the web browser: conducting a web page processing of a web page retrieved from a web based data source; establishing a resulting first internal browser state representation of the web page in the web browser; establishing an external representation; the external representation representing a state of the first internal representation; wherein the establishing of the external representation of the state comprises: establishing a representation of a first content of the first internal browser state representation; establishing a dynamic content state representation which represents the state of the dynamic content of the first internal browser state representation; and establishing mapping data comprising a mapping of relationships between the dynamic content and the first content; and making the external representation available to a web browser application so as to establish a further internal representation of the web page in the web browser application at a state corresponding to the state of the first internal browser state representation.

In another embodiment, a system is configured for establishing external representations of a first internal browser state representation of a web browser and establishing a further internal representation based thereon. The system includes: a web browser configured for externalizing the first internal browser state representation into an external representation of the state, and a web browser application is configured for establishing the further internal state representation based on the external state representation at a browser state corresponding to the state of the first internal browser state representation. Establishing the external representation of the state comprises: establishing a representation of a first content of the first internal browser state representation; establishing a dynamic content state representation which represents the state of the dynamic content of the first internal browser state representation; and establishing mapping data comprising mapping of relationships between the dynamic content and the first content of the first internal browser state representation.

In yet another embodiment, a web browser is configured for establishing external browser state representations by: establishing an external representation of a first content of a first internal browser state representation, establishing an external dynamic content state representation which represents the state of the dynamic content of the first internal representation, and establishing mapping data comprising mapping of relationships between the dynamic content and the first content of the first internal browser state representation.

In additional approaches, a web browser is configured for establishing a further internal browser state representation based on a pre-established external browser state representation by: processing a pre-established external browser state representation, parsing the result of the processing into an internal Document Object Model of the web browser application, and processing mapping data of the external browser state representation, and implementing relationships between dynamic content and first content represented in the internal Document Object Model based on the mapping data.

In still yet another embodiment, a method is directed to browsing web based data sources comprising a plurality of web pages. The method includes, using the web browser: browsing one or more web pages of the web based data source; establishing at least two external representations of different first internal browser states during the browsing; establishing, at least partially based on processing the content of the external representations, one or more additional browsing events based on at least one of the external representations in one or more web browser applications; and performing a parsing into an internal state representation of the one or more web browser applications.

### BRIEF DESCRIPTION OF THE DRAWINGS

The presently disclosed inventive concepts will be explained in further detail below with reference to the Figures.

FIG. 1 illustrates a system, according to several embodiments of the presently disclosed inventive concepts.

FIG. 2 illustrates a flow chart relating to an embodiment of establishing an external representation according to embodiments of the presently disclosed inventive concepts.

FIG. 3 illustrates a flow chart relating to an embodiment of establishing a further internal state representation in a web browser based on an external representation according to embodiments of the presently disclosed inventive concepts.

FIG. 4: illustrates schematically mapping of relationships according to embodiments of the presently disclosed inventive concepts,

FIG. 5 illustrates a further embodiment of establishing an external representation to embodiments of the presently disclosed inventive concepts,

FIG. 6 illustrates a web browser according to embodiments of the presently disclosed inventive concepts,

FIG. 7 illustrates an embodiment of the presently disclosed inventive concepts relating to establishing a plurality of further internal state representations

FIG. 8 illustrates a further embodiment of the presently disclosed inventive concepts relating to establishing a plurality of further internal state representations based on a pre-established external representation, e.g. by means of a server.

FIG. 9 illustrates a client according to embodiments of the presently disclosed inventive concepts.

FIG. 10 illustrates embodiments of a web server according to aspects of the presently disclosed inventive concepts,

FIG. 11 illustrates an embodiment of the presently disclosed inventive concepts wherein an external representation is stored at a client,

FIG. 12 illustrates an embodiment of the presently disclosed inventive concepts relating to the use of a plurality of external browser state representations,

FIG. 13 illustrates an embodiment of an external representation according to embodiments of the presently disclosed inventive concepts,

FIG. 14 illustrates an example of a web page visualized on a screen by a web browser according to embodiments of the presently disclosed inventive concepts, and

FIGS. 15-16 illustrate embodiments of the presently disclosed inventive concepts where computer implemented web robots uses external state representations during browsing.

Of course, the aforementioned Figures are to be understood as merely illustrative demonstrations of exemplary embodiments within the scope of the presently disclosed inventive concepts. Additional embodiments, variations on the aforementioned embodiments, and alternative embodiments are also to he considered fully within the scope of the present, application, according to the understanding achieved by one having ordinary skill in the art upon reading these descriptions.

### DETAILED DESCRIPTION

The description herein is presented to enable any person skilled in the art to make and use the invention and is provided in the context of particular applications of the invention and their requirements. Various modifications to the disclosed embodiments will be readily apparent to those skilled in the art and the general principles defined herein may he applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (cg., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium, In addition, although specific embodiments of the invention may employ object-oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc,

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems, Cloud computing typically involves an Internet or other high speed connection (e.g., 4G LTE, fiber optic, etc.) between the systems operating in the cloud, but other techniques of connecting the systems may also be used.

In one embodiment, a method includes: by means of a web browser conducting a web page processing of a web page retrieved from a web based data source, and establishing a resulting first internal browser state representation of the web page in the web browser, establishing an external representation of a state of the first internal representation during the web page processing, wherein the establishing of the external representation of the state comprises: establishing a representation of a first content of the first internal browser state representation, establishing a dynamic content state representation which represents the state of the dynamic content of the first internal browser state representation, and establishing mapping data comprising mapping of relationships between the dynamic content and the first content of the first internal browser state representation.

In another embodiment, the method further comprising the step of making the external representation available to a web browser application so as to establish a further internal representation of the web page in the web browser application at a state corresponding to the state of the first internal browser state representation.

The presently disclosed inventive concepts preferably facilitate extracting and storing one or more web browser states, e.g. between two Uniform Resource Locator visits by means of the browser. An URL is also known as a web addresses. These browser states may then be re-established in other web browser applications or the same web browser application at a later time. Hence, it is possible for e.g. a web robot developer and/or a web robot to return to a previous state at a later point in time. This is facilitated by processing the external representation an as to establish the further internal representation. The user or web robot will hence, when browsing the web page after the establishment of the further internal representation, be able to browse the web page as it was presented at the time of externalizing the first internal browser state representation. Hence, a looping feature is facilitated that a user or web robot may follow different browsing paths from the first internal state representation without experiencing that previous user or scripting actions have modified the state.

The term “web browser” and “web browser application” relates to software applications for retrieving and presenting web pages on the World Wide Web. The web pages may comprise data such as images, text, videos, scripting content and/or other piece of content. The web pages may comprise hyperlinks to enable users to easily navigate their browser to related resources. The web pages are often dynamic web pages with content that varies based on e.g. parameters provided by or manipulated by a user or a computer program such as scripting content.

It is understood that in aspects of the presently disclosed inventive concepts, the further internal representation may be implemented in the same web browser that may have been used for establishing the first initial internal browser state representation that an external representation represents. However, as described later on, the further internal representation may also he implemented in a further web browser application so that this web browser application is at a state corresponding to the state of the first internal representation.

Since the further internal representation may be based on the external state representation, the further internal representation may be established by the web browser application to be substantially corresponding to the first internal representation. By this, a user that performed a series of interactions with the web page which resulted in the first internal representation would be able to recognize the further internal representation in the same or a new web browser, and continue from this point. Due to the mapping, the states of the dynamic content and the other content of the internal representation at the state where the external representation is established, is able to be reproduced, including the state of the dynamic content at that state.

The presently disclosed inventive concepts moreover results in a state representation that is robust with respect to scripting performed during a web page processing of a dynamic web page. Such scripting may modify the internal representation of the dynamic web page due to user-triggered actions as well as scripting triggered actions, Such actions dynamically modifies the internal representation of the web page so that the web page can appear different and contain different content in different web browsers dependent on user actions and the state of the scripting content However, due to among other the mapping data, the state of the browser can be carefully and extensively represented externally so as to provide the opportunity of a subsequent restoring of a state corresponding to the state of the first internal browser state representation.

Moreover, in preferred aspects of the presently disclosed inventive concepts, the first content of the first internal browser state representation may be established in a first format, the dynamic content state representation may be established in a second format, and the mapping data may be established in a third format. So, in aspects of the presently disclosed inventive concepts, different formats for the different parts representing the external representation may be used. This may e.g. provide a more reliable and/or efficient establishing of a further internal representation based on the external representation may be established. Thereby, one format may be advantageous in relation to e.g. establishing the dynamic representation in the web browser, but may be less advantageous if used for e.g. the mapping data.

In advantageous aspects of the presently disclosed inventive concepts, the establishing of the external state representation comprises serializing at least a part of the first internal browser state representation.

The serialization may result in a translation/conversion of a state of the first internal representation into a format that may be stored (for example, in a file or memory buffer) external to the web browser, and rebuild later in the same or another web browser. During the serialization, the first internal representation is processed by a computer program and serialized according to a predetermined serialization format.

The serialized data may then be used to create the further internal representation of the state of the first internal representation. The serialization may hence comprise translating data structures and/or object states if the internal representation in the web browser into a format that may be stored and which reflects the state of the browser.

The mapping data may in aspects of the presently disclosed inventive concepts be established during the serialization according to a serialization format.

Also, the serialization may moreover in aspects facilitate a conversion of parts of the first internal representation, e.g. an internal Document Object Model of the web browser, into different formats.

The serialization hence facilitates extraction of the first internal representation into the external representation so that a “snapshot” of the state of the web browser is established efficiently and controlled.

In advantageous aspects of the presently disclosed inventive concepts, the web browser comprising the first internal representation comprises means for processing the first internal representation to establish the external representation.

In aspects of the presently disclosed inventive concepts, the establishing of the external state representation comprises serializing dynamic content and/or at least a part of the first content of the first internal browser state representation.

The serialized dynamic content and/or part of the first content is then stored as the external representation. This e.g. provides an efficient way of establishing an external representation.

In advantageous aspects of the presently disclosed inventive concepts, the establishing of the further internal representation comprises deserializing at least a part of the external representation.

The deserializing may be facilitated by the web browser application that is intended for the further internal representation, and may comprise processing of the external representation to allocate data memory at the client or web server comprising the web browser application and the like. For example XML may be considered especially advantageous in relation to provide an external representation of e.g. HTML content or other markup content of the internal representation in that it is strictly/unambiguously represented and will provide a reliable representation that may be parsed precisely in connection with establishing a further representation based on the external representation. However, any other format may also be relevant in other aspects.

In aspects of the presently disclosed inventive concepts, the establishing of the further internal representation comprises parsing at least a part of the external representation into the web browser application.

The parsing is preferably facilitated by the web browser application that is intended for the further internal representation. The parser may parse style sheet content, markup language content and other content that originates from the external representation into an internal Document Object Model representation in the web browser application. For this purpose, the web browser application may comprise a markup language parser such as a HTML parser, a XML parser, a style sheet (CSS) parser and/or the like so as to parse content of the external representation into the web browser application to establish an internal DOM in the browser

In preferred aspects of the presently disclosed inventive concepts, the external representation may he established to be independent of memory locations of the first internal representation.

This may e.g. be facilitated by the serializing and/or other processing of the first internal representation, by mapping relations between objects of the first internal representation as described in more details later on and/or the like. The external representation may thereby be even more generic and facilitate easy/advantageous implementation in further browsers.

In advantageous aspects of the presently disclosed inventive concepts, the establishing of the external representation may comprise identifying frames, such as inline frames (Iframes), of the web page.

Dynamic web pages often comprise a plurality of frames Such frames may be represented in each their different Document Object Models of the first internal representations, and to facilitate a subsequent re-establishing of the state of such frames, the frames may be advantageous to identify to provide a proper external representation. The identification of the frames may e.g. be achieved by having a software application processing the DOM of the internal representation.

In aspects, an external representation may be established for two or more frames, such as inline frames (Iframes), of the web page.

Each frame of the first internal representation may hence comprise its own external frame representation in the external representation so as to enable a more convenient establishing of the first internal state representation later on.

In aspects, the establishing of the external representation may comprise establishing a frame association representation.

The frame association representation may e.g. comprise information of a frame tree of the first internal representation so that the frames represented can be set up accordingly in the further internal representation in a web browser.

In advantageous aspects of the presently disclosed inventive concepts, the external representation is established based on an internal Document Object Model representation of the web page in the web browser.

The internal document object model of the web browser comprising the first internal representation continuously at least partly represents the state of the browser, and thus it is convenient to process the Internal Document Object Model of the web browser.

In advantageous aspects, the external representation may be established by serializing at least a part of the content of the internal Document Object Model.

This serializing may e.g. help to provide a consistent and reliable external state representation.

The further internal representation may in aspects of the presently disclosed inventive concepts be established by deserializing at least a pan of the external representation and parsing the result of the deserializing into a resulting internal Document Object Model of the web browser application.

The deserializing may e.g. help to provide a consistent and reliable external state representation which takes into account the circumstances wider which the external representation is implemented, for example software and/or hardware of the client on/at which the further internal representation is to be established.

In aspects, the first content of the first internal browser state representation comprises markup content, and the external representation comprises a representation of the markup content.

The state of the so to say “static” content of the web browser is hence externalized into the external representation, preferably by serializing the markup language content.

It is to be understood that the markup content, may also be referred to as markup language content, comprises the internal representation of the web page that has been established by the web browser during parsing of the web page into the web browser.

Advantageously, the first content of the internal browser state representation may in aspects comprises a representation of style sheet content, and the external representation may comprise a representation of the style sheet content.

It is to be understood that the style sheet content, comprises the internal representation of the web page that has been established by the web browser during parsing of style sheet content of the web page into the browser.

The first content may in aspects of the presently disclosed inventive concepts comprise cookie data related to the first internal browser state representation, and the external representation may comprises a representation of the cookie data.

The cookie data may e.g. be relevant to facilitate establishment of a further internal representation where data related to the user during the browsing to end up with the first internal representation may be relevant. Hence, the cookie data may be derived from the browser application containing the internal representation into the external representation

In aspects of the presently disclosed inventive concepts, the first content may comprise form content of the first internal browser state representation, and the external representation may comprise a representation of the form content.

This may e.g. be relevant in aspects where filled in forms form the basis for further browsing of a web page, and hence, by externalizing and implementing the filled in content of these forms, it may be possible to establish a state of a browser that enables browsing of the web page without filling in the Corms. This may be especially relevant to web robots that may not be able to fill in the forms. And moreover, a user may before establishment of the external representation fill in forms with content that defines how web robot should process data in a further internal representation. The form content may be derived from the internal representation so that the external representation comprises this information for later use.

In advantageous aspects of the presently disclosed inventive concepts, the mapping data comprises mapping of relations between the dynamic content and markup content of the first internal browser state representation.

The dynamic content of a web page may access and/or modify content such as objects of the markup content of the internal representation. Therefore, to enable establishment of a browser state corresponding to the first internal state, such relations may be advantageous to map.

In advantageous aspects of the presently disclosed inventive concepts, the mapping data comprises mapping of pointers between the dynamic content and style sheet content of the first internal browser state representation.

In aspects of the presently disclosed inventive concepts, the mapping data comprises mapping of pointers to memory addresses of objects of the first internal browser state representation.

Pointers of e.g. the dynamic content such as scripting content of the first internal representation may point to memory addresses of objects of e.g. the style sheet content and/or markup content of the first internal representation. These memory addresses may however not be usable in a. further internal representation in that the memory location changes over time depending on different processing events. For example, after an external representation has been established, the user may continue to browse, and this may influent on the memory addresses so that previous objects are substituted, amended or even deleted from the memory. Also, if the further internal representation is located at another client or web server than the one used for establishing the first internal representation, the data storage means and the internal setup of such may be completely different

Therefor such mapping may be advantageous to identify the objects of the memory addresses that a pointer points towards so as to provide the possibility of reestablishing of such relations later on in a further internal representation. It is however understood that other or additional types of mapping may be used in further aspects of the presently disclosed inventive concepts.

In aspects of the presently disclosed inventive concepts, the establishing of mapping data may comprise processing of the first internal representation so as to identify and map pointers between objects.

Hence, the pointers between the dynamic content and first content such as e.g. markup language content and/or style sheet content of the first internal representation may be reestablished in the further representation. These pointers may vary over time dependent on the web page processing, user input, scripting of the web page and the like.

For example, a pointer may refer/point to another value stored elsewhere in a data memory address of the client processing the web page to establish the first representation. Such pointers hence contain information regarding how to rebuild the first internal representation in the further representation so that pointers of the further representation can be reestablished independently of the memory allocation of the first representation. Even though a value at a given memory location at the client may be extracted in connection with e.g. establishing a representation of an internal Document Object model, a pointer to this value when implemented in the further representation may be necessary so as to reestablish the state of the first representation in the further representation.

An object is to be considered as a location in a data memory having a value and referenced by an identifier that identifies the object. The object may e.g. be a variable, a function, or data structure.

The mapping of pointers may in aspects of the presently disclosed inventive concepts be achieved by a so called “unswizzling” during serialization of the internal representation,

In aspects of the presently disclosed inventive concepts, the establishing of the external representation comprises converting the first data content into one or more formats different from the format of the internal browser state representation.

The the conversion may in preferred aspects be performed during serializing of the internal representation.

In aspects of the presently disclosed inventive concepts, the establishing of the external representation may comprise converting a part of the first internal browser state representation into an external representation of an internal Document Object Model of the first internal representation, e.g. in an Extensible Markup Language. This may provide advantages in relation to determining and re-establishing the internal representation.

In aspects of the presently disclosed inventive concepts, the establishing of the external representation comprises converting a plurality of internal Document Object Models of different frames of the first Internal representation into or e or more external representations of the plurality of Internal Document Object Models.

Thus, a more profound representation of the state representation may be achieved which facilitates a reliable and/or flexible external representation that will be more easy and reliable to use later on.

In aspects, the conversion comprises converting markup content of the first internal browser state representation into a markup Language format such as an Extensible Markup Language (XML) format.

This conversion facilitates an advantageous later processing of the external representation. This content may in preferred aspects represent at least a part of the internal DOM of the web browser.

In aspects, the conversion comprises converting style information of the first internal browser state representation into a cascading style sheet format.

This style sheet format may hence be used directly during parsing of the style sheet content to establish the further representation.

The establishing, of an external representation may in aspects comprise establishing a plurality of individual representations of different content of the first internal browser state representation.

The external representation may hence comprise a style sheet file (e.g. .css) relating to the style sheet data of the first internal representation at the state, a markup language file (e.g. XML) relating to the style sheet data of the first internal representation at the state, a file comprising the state of the dynamic content of the first internal representation at the state (e.g. in a scripting language), a text file with cookie data comprising a representation of cookies relating to the first internal representation at the state, a representation of form content of the first internal representation at the state, and a file comprising mapping information as described in this document. So the external representation may comprise a plurality of data files together representing the state of the first internal representation.

In advantageous aspects of the presently disclosed inventive concepts, the establishment of the further internal representation may comprise reconnecting browser markup language content and dynamic content in the web browser application based on the mapping data. Advantageously, the establishment of the further internal representation may comprise reestablishing pointers between objects of the further internal representation based on the mapping data.

After deserializing and parsing the content of the external state representation into the web browser application, objects and in aspects also object values corresponding to the objects of the first internal representation are established. However, the relations in the form of e.g. pointers between such objects may still need to be established, and hence the mapping data is processed by the web browser application to reestablish relations between such objects.

The reestablishing of the pointers may in aspects of the presently disclosed inventive concepts be achieved during the deserialization by a so called “pointer swizzling” which may e.g. perform a conversion of references based on object names/identifiers.

The first internal representation and the further internal representation may in aspects of the presently disclosed inventive concepts be incorporated/represented in different web browsers.

Thereby, it may e.g. be possible to continue browsing from the same web browser state in different web browsers. This may be especially advantageous in relation to delegating browsing tasks between different users and/or web robots and in relation to developing web robots.

In aspects of the presently disclosed inventive concepts, the method comprises the step of establishing a plurality of further internal representations in different web browser applications, based on the external representation.

Hereby, a plurality of web robots and/or users may continue browsing one or more times from the same web browser state over time.

Moreover, web browsers may be made more efficient in that they may facilitate looping to follow different paths from the web browser state, and when a path has been sufficiently examined by the web robot or user, the external state representation may be reintroduced to reestablish the previous web browser state,

The web page processing of the web page may in aspects comprise processing dynamic content of the web page during browsing of the web page.

The web browser may generally, in aspects in such aspects comprise a script engine, such as a java script engine, which is configured for processing scripting content of the web page. During this, pointers between object of the dynamic content to other objects in the internal DOM, such as objects relating to markup content and/or style sheet content, may be established and/or updated by the web browser.

In preferred aspects, the dynamic content of the web page includes scripts of the web page.

A dynamic web page often comprises a plurality of dynamic content such as e.g. of scripts to be executed e.g. client side, by the web browser. Such dynamic content adapts over time during representation in the web browser.

For example, the dynamic content may be JavaScript (or another scripting language) content that modifies the web page representation and/or behaviour in response to mouse, keyboard and/or touch screen actions performed by a user browsing the web page, it may he at specified timing events and/or the like. For example, when a user “scrolls” the presented web page, the script may be set to automatically collect additional content and/or update the web page automatically.

The dynamic content of the web page may also in aspects comprise content which is a result of server side scripting. Server side scripting content is understood as that content of the web page is controlled or updated based on one or more programs running on a web server, which is/are used to change the web content and/or appearance on the web page. These embedded scripts results in that a client's request to the server website is handled by one or more scripts running server-side on a web server before the server responds to the client's request. For example, the server-side scripting may receive data that a user has entered in input fields presented to the user on a screen and/or data that is established during the user's browsing. This data is then transmitted by an embedded script of the web page to the server side script which processes the data and returns data to the browser according to the result.

In advantageous aspects, the web browser comprising the first internal representation externalizes the first internal browser state representation into the external representation, preferably by means of serializing means for serializing at least a part of the first internal representation.

The web browser application for use with the further internal representation may in aspects establish the further internal representation, preferably by means of deserializing means for deserializing at least apart of the external representation.

The deserialized content may hence be parsed into the internal DOM by means of the web browser application after the deserializing.

The web browser comprises the internal state representation of a web page which is given by the web page, user interactions, dynamic content and/or the like. Hence, by configuring the web browser for establishing the external representation and/or the further internal representation, the web browsers may be able access its internal representation and externalize its exact state of the web browser at the time of the externalization into the external state representation.

Alternatively, means being external to the web browser may be able to take a copy of the web browser state such as e.g. a copy of the internal DOM, form data, cookie data and the like of the web browser, and then subsequently establish the external representation by processing the copied data.

In advantageous aspects of the presently disclosed inventive concepts, a web robot may be configured for initiating establishment of one or more external representations when predefined criteria are complied with, and/or the web robot may he configured for establishing one or more further internal representations based on an external representation.

The presently disclosed inventive concepts moreover relates to a system for establishing external representations of a first internal browser state representation of a web browser and establishing a further internal representation based thereon, the system comprising a web browser configured for externalizing the first internal browser state representation into an external representation of the state, wherein the establishing of the external representation of the state comprises establishing a representation of a first content of the first internal browser state representation, establishing a dynamic content state representation which represents the state of the dynamic content of the first internal browser state representation, and establishing mapping data comprising mapping of relationships between the dynamic content and the first content of the first internal browser state representation, and wherein a web browser application is configured for establishing the further internal state representation based on the external state representation at a browser state corresponding to the state of the first internal browser state representation.

In aspects of the above mentioned system, the system is configured for operating according to a method of any of claims 1 to 35.

Additionally, the presently disclosed inventive concepts relates to use of a method and/or system according to any of claims 1 to 37 together with one or more web robots, wherein the one or more web robots are configured for initiating establishment of a further internal representation of a web page in a web browser application at a state corresponding to a state of a first internal browser state representation, and wherein the further internal representation is established based on an external state representation.

Also, the presently disclosed inventive concepts relates to a further use of a method, system and/or use according to any of claims 1 to 38 for establishing a plurality of browsing events in different web browser applications.

In aspects of the further use, the plurality of the browsing events may be executed on one or more servers. The server may hence in aspects host server executed web robots. This provides an efficient and effective solution for providing fast and efficient browsing of web pages, preferably substantially simultaneously by one or more of web robots.

Additionally, the presently disclosed inventive concepts relates to a first web browser for establishing external browser state representations, the web browser comprising means for establishing an external representation of a first content of a first internal browser state representation, means for establishing an external dynamic content state representation which represents the state of the dynamic content of the first internal representation, and means for establishing mapping data comprising mapping of relationships between the dynamic content and the first content of the first internal browser state representation.

The term “means” may generally also in aspects be regarded as an arrangement or an application.

In aspects, the first web browser may be configured for operating in accordance with the method of any of claims 1-35.

Moreover, the presently disclosed inventive concepts relates to a second web browser application for establishing a further internal browser state representation based on a pre-established external browser state representation, the web browser application comprising: means for processing a pre-established external browser state representation, means for parsing the result of the processing into an internal Document Object Model of the web browser application, and means for processing mapping data of the external browser state representation, and implementing relationships between dynamic content and first content represented in the internal Document Object Model based on the mapping data.

In aspects of the second web browser, the second web browser may be configured for operation in accordance with the method of any of claims 1-35.

The web browser(s) disclosed above may be considered as a computer program product comprising computer readable used for processing of web pages. The web browsers may beyond the above means for establishing and handling the external representation comprise additional conventional means for processing web pages such as parsers, a layout engine, data communication layers and/or the like to facilitate browsing of web pages.

Additionally, the presently disclosed inventive concepts relates to a method of browsing web based data sources comprising a plurality of web pages, the method comprising the steps of: browsing one or more web pages of the web based data source by means of a web browser, by means of the web browser establishing at least two external representations of different first internal browser states during the browsing, establishing one or more additional browsing events based on at least one of the external representations in one or more web browser applications, the establishment of the one or more additional browsing events comprising processing the content of the external representations and performing a parsing into an internal state representation of the one or more web browser applications.

In aspects of the method of browsing web based data sources, the at least two external representations may be established and/or implemented into one or more web browser applications according to the method of any of claims 1-35 and/or by means of a system according to any of claims 36-37.

In aspects of the method of browsing web based data sources, the method is performed by a web robot.

Alternatively, a user may in aspects of the presently disclosed inventive concepts perform at least a part of the browsing. In the event that a robot performs apart of the browsing, this part of the browsing is not necessarily monitored on a screen of a computer.

Additionally, the presently disclosed inventive concepts relates to use of a web robot for browsing web pages by means of a web browser, wherein the web robot operates according to a predefined set of rules so as to process one or more web pages, and wherein the web robot is configured for initiating establishment of one or more external representations according to any of claims 1- 35 when predefined criteria is complied with.

In aspects, the predefined criteria may relate to criteria relating to e.g. the processing of a web page. E.g. when a web browser processing of the web page fulfil one or more criteria such as criteria relating to the status of executed scripting content, executed parsed content, the status of style sheet information and/or the like, these criteria may trigger establishment of an external representation, e.g. according to one or more methods described in this document,

The presently disclosed inventive concepts may moreover relate to a further method of establishing a state representation of a web page represented in a web browser, the method comprising the following steps: by means of a web browser conducting a web page processing of a web page retrieved from a web based data source, and establishing a resulting first internal browser state representation of the web page in the web browser, establishing an external representation of a state of the first internal representation during the web page processing, wherein the establishing of the external representation of the state comprises establishing a representation of a first content of the first internal browser state representation, establishing a dynamic content state representation which represents the state of the dynamic content of the first internal browser state representation, and establishing mapping data comprising mapping of relationships between the dynamic content and the first content of the first internal browser state representation, and storing the external representation at a data storage.

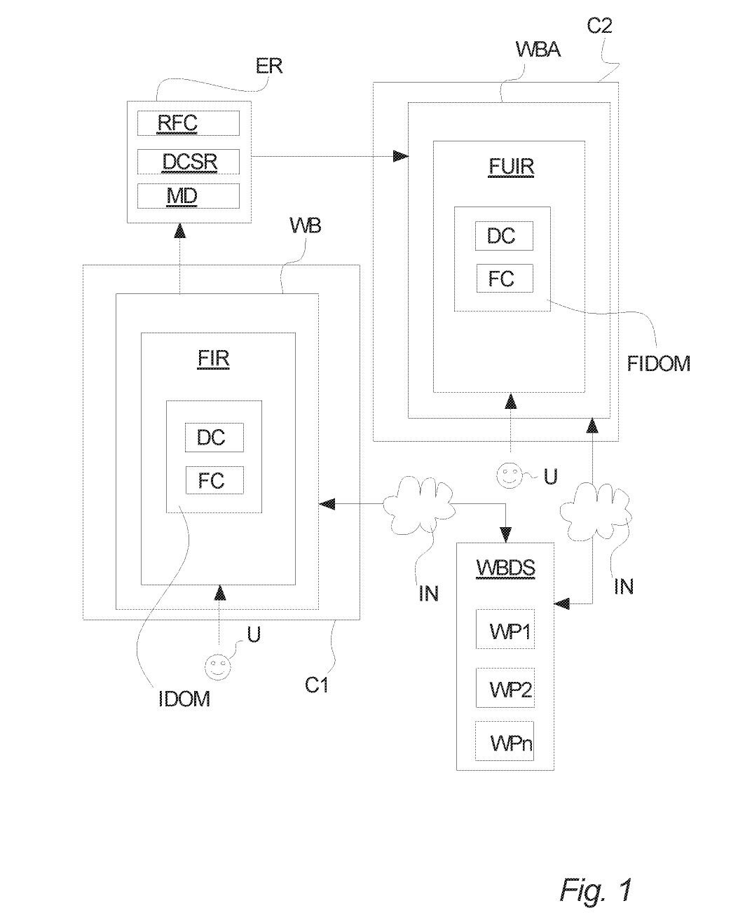

This embodiment of the further method above may be combined with any suitable embodiment described in relation to e.g., FIGS. 1-11.

It is generally understood that the establishing of the external representation(s) and/or the use of external representation(s) for reestablishing a browser state may be computer implemented so as to substantially automatically generate an external state representation or use/implement an external state representation upon request from e.g. a user or a web robot.

In one general approach, a method of establishing a state representation of a web page represented in a web browser includes performing the following operations using the web browser: conducting a web page processing of a web page retrieved from a web based data source; establishing a resulting first internal browser state representation of the web page in the web browser; establishing an external representation; the external representation representing a state of the first internal representation; wherein the establishing of the external representation of the state comprises: establishing a representation of a first content of the first internal browser state representation; establishing a dynamic content state representation which represents the state of the dynamic content of the first internal browser state representation; and establishing mapping data comprising a mapping of relationships between the dynamic content and the first content; and making the external representation available to a web browser application so as to establish a further internal representation of the web page in the web browser application at a state corresponding to the state of the first internal browser state representation.

In another general embodiment, a system is configured for establishing external representations of a first internal browser state representation of a web browser and establishing a further internal representation based thereon. The system includes: a web browser configured for externalizing the first internal browser state representation into an external representation of the state, and a web browser application is configured for establishing the further internal state representation based on the external state representation at a browser state corresponding to the state of the first internal browser state representation, Establishing the external representation of the state comprises: establishing a representation of a first content of the first internal browser state representation; establishing a dynamic content state representation which represents the state of the dynamic content of the first internal browser state representation; and establishing mapping data comprising mapping of relationships between the dynamic content and the first content of the first internal browser state representation.

In yet another general embodiment, a web browser is configured for establishing external browser state representations by: establishing an external representation of a first content of a first internal browser state representation, establishing an external dynamic content state representation which represents the state of the dynamic content of the first internal representation, and establishing mapping data comprising mapping of relationships between the dynamic content and the first content of the first internal browser state representation.

In additional general approaches, a web browser is configured for establishing a further internal browser state representation based on a pre-established external browser state representation by: processing a pre-established external browser state representation, parsing the result of the processing into an internal Document Object Model of the web browser application, and processing mapping data of the external browser state representation, and implementing relationships between dynamic content and first content represented in the internal Document Object Model based on the mapping data.

In still yet another general embodiment, a method is directed to browsing web based data sources comprising a plurality of web pages. The method includes, using the web browser: browsing one or more web pages of the web based data source; establishing at least two external representations of different first internal browser states during the browsing; establishing, at least partially based on processing the content of the external representations, one or more additional browsing events based on at least one of the external representations in one or more web browser applications; and performing a parsing into an internal state representation of the one or more web browser applications.

In preferred approaches, the inventive embodiments disclosed herein may include any number of the following functions, features, and/or components:

Establishing a state representation of a web page represented in a web browser, may include, using the web browser: conducting a web page processing of a web page retrieved from a web based data source; establishing a resulting first internal browser state representation of the web page in the web browser; establishing an external representation; the external representation representing a state of the first internal representation; wherein the establishing of the external representation of the state may include: establishing a representation of a first content of the first internal browser state representation; establishing a dynamic content state representation which represents the state of the dynamic content of the first internal browser state representation; and establishing mapping data comprising a mapping of relationships between the dynamic content and the first content; and making the external representation available to a web browser application so as to establish a further internal representation of the web page in the web browser application at a state corresponding to the state of the first internal browser state representation. Establishing of the external state representation may include serializing at least a part of the first internal browser state representation. The part of the first internal browser state representation may include at least a portion of one or more of the dynamic content and the first content. Establishing of the further internal representation may include deserializing at least a part of the external representation. Establishing of the further internal representation may include parsing at least a part of the external representation into the web browser application, The external representation may be established to be independent of one or more memory locations, the one or more memory locations corresponding to the first internal representation. Establishing of the external representation may include a plurality of identifying frames, the plurality of identifying frames comprising one or more inline frames of the web page. An external frame representation may be established for each of two or more frames, at least one of the two or more frames comprising at least one inline frame of the web page. Establishing of the external representation may include establishing a frame association representation. The external representation may be established based on an Internal Document Object Model representation of the web page in the web browser. The external representation may he established by serializing at least a part of the content of the Internal Document Object Model. Establishing the further internal representation may include: deserializing at least a part of the external representation; and parsing the deserialized part of the external representation into an Internal Document Object Model of the web browser application. The first content of the first internal browser state representation may include markup content, and the external representation may include a representation of the markup content. The first content of the internal browser state representation may include a representation of style sheet content, and the external representation may include a representation of the style sheet content. The first content may include cookie data related to the first internal browser state representation, and the external representation may include a representation of the cookie data. The first content may include form content of the first internal browser state representation, and the external representation may include a representation of the form content. The mapping data may include mapping of one or more relations between the dynamic content and markup content of the first internal browser state representation. The mapping data may include mapping of pointers between the dynamic content and style sheet content of the first internal browser state representation. The mapping data may include mapping of one or more pointers to one or more memory addresses of one or more objects of the first internal browser state representation. Establishing the mapping data may include: processing the first internal representation; identifying one or more pointers between the objects based at least in part on the processing; and mapping the pointers to the memory addresses. Establishing of the external representation may include converting the first content into one or more formats, each of the one or more converted formats being different from a format of the internal browser state representation. Establishing of the external representation may include converting at least a part of the first internal browser state representation into an external representation of an Internal Document Object Model of the first internal representation. Establishing of the external representation may include converting a plurality of Internal Document Object Models of different frames of the first internal browser state representation into one or more external representations of the plurality of Internal Document Object Models. The first internal browser state representation may include markup content, and the converting may include formatting at least some of the markup content into a markup Language format. The first internal browser state representation may include style information, and the converting may include formatting at least some of the style information into a cascading style sheet format. The first internal browser state representation may include a plurality of different content elements, each different content element comprising at least a portion of one or more of the first content; and the dynamic content. Establishing of the external representation further may include establishing a plurality of individual representations, each individual representation being based on the first internal browser state representation, and each individual representation may correspond to at least one of the plurality of different content elements. Establishing the further internal representation may include mapping at least one connection between a representation of the browser markup language content and dynamic content in the web browser application, and the mapping may he based at least in part on the mapping data. Establishing the further internal representation may include establishing one or more pointers between one or more objects of the further internal representation, wherein the establishing may be based at least in part on the mapping data. Each of the first internal representation and the further internal representation are incorporated in one or more of: at least one web browser; at least one web browser application; and at least one web page. The first internal representation and the further internal representation are incorporated in either or both of a different one of the one or more web browser(s), web browser application(s) and web page(s); and a different type of the one or more web browser(s), web browser application(s) and web page(s). Establishing a plurality of further internal representations in a plurality of web browser applications, wherein each of the plurality of web browser applications in which the further internal representation(s) may be/are established may be different from every other of the web browser applications in which the further internal representation(s) may be/are established. The web page processing of the web page may include processing the dynamic content of the web page during a browsing operation, the browsing operation operating on the web page. The dynamic content of the web page may include scripts of the web page, The web browser comprising the first internal representation externalizes the first internal browser state representation into the external representation based at least in part on serializing at least a portion of the first internal representation. The web browser application for the further internal representation may establish the further internal representation based at least in part on deserializing at least a portion of the external representation. Additionally and/or alternatively, and preferably using a web robot, it is advantageous to facilitate: determining whether one or more predefined criteria are satisfied; and initiating the establishing the external representation based at least in part on determining one or more of the predefined criteria are satisfied. The web robot may be configured for establishing one or more further internal representations based on an external representation, A system may be configured for establishing external representations of a first internal browser state representation of a web browser and establishing a further internal representation based thereon. The system includes: a web browser configured for externalizing the first internal browser state representation into an external representation of the state, wherein the establishing of the external representation of the state may include: establishing a representation of a first content of the first internal browser state representation; establishing a dynamic content state representation which represents the state of the dynamic content of the first internal browser state representation; and establishing mapping data comprising mapping of relationships between the dynamic content and the first content of the first internal browser state representation. Within the system, a web browser application may be configured for establishing the further internal state representation based on the external state representation at a browser state corresponding to the state of the first internal browser state representation. The system may be configured for operating according to the foregoing methods, optionally in conjunction with one or more web robots, and the one or more web robots are configured for initiating establishment of a further internal representation of a web page in a web browser application at a state corresponding to a state of a first internal browser state representation, The further internal representation may be established based on an external state representation. These concepts are useful for establishing a plurality of browsing events in one or more different web browser applications, even if the plurality of the browsing events are executed on one or more servers. A web browser may be configured for establishing external browser state representations. The web browser includes: means for establishing an external representation of a first content of a first internal browser state representation, means for establishing an external dynamic content state representation which represents the state of the dynamic content of the first internal representation, and means for establishing mapping data comprising mapping of relationships between the dynamic content and the first content of the first internal browser state representation. A web browser application may be configured for establishing a further internal browser state representation based on a pre-established external browser state representation, The web browser application includes: means for processing a pre-established external browser state representation, means for parsing the result of the processing into an internal Document Object Model of the web browser application, and means for processing mapping data of the external browser state representation, and implementing relationships between dynamic content and first content represented in the internal Document Object Model based on the mapping data. A method of browsing web based data sources including web pages, includes: browsing one or more web pages of the web based data source by means of a web browser, establishing at least two external representations of different first internal browser states during the browsing, establishing one or more additional browsing events based on at least one of the external representations in one or more web browser applications, the establishment of the one or more additional browsing events comprising processing the content of the external representations and performing a parsing into an internal state representation of the one or more web browser applications. The at least two external representations may be established and/or implemented into one or more web browser applications according to the foregoing method(s) and/or system(s). Again, the method may be performed by a web robot, particularly to accomplish browsing web pages by means of a web browser. The web robot operates according to a predefined set of rules so as to process one or more web pages, and the web robot may be configured to initiate establishment of one or more external representations according to any of the foregoing method(s) and/or system(s) in response to determining one or more predefined criteria are complied with.

Additional features, functions, components, and advantages presented by the currently-disclosed inventive concepts will be presented with reference to the Figures. The following descriptions are to be understood as exemplary, and any of the features presented may be combined, substituted, in any suitable manner that would be appreciated by a skilled artisan upon reading these disclosures.

FIG. 1 illustrates a system according to embodiments of the presently disclosed inventive concepts. The system comprises a first client C1 and a second client C2. The clients in this example are computing units such desktops, laptops, tablet computers and/or the like, but it is understood that a server comprising one or more web robots may also be considered as a client in further embodiments of the presently disclosed inventive concepts. The clients C1, C2 comprise one or more data processors/CPUs, data storage(s), circuit boards, screens, and may comprise input means such as a keyboard (hardware or software (via touch screen)) a computer mouse and/or similar.

Moreover, the clients C1, C2 comprises web browser means WB, WBA. These web browser means are software applications adapted for accessing, processing and presenting web pages WP1-WPn on the World Wide Web, also called the internet IN. These web pages WP1-WPn are located at web based data sources WBDS.

The web browser(s) WB, WBA may hence comprise any suitable means enabling that the web browser can access, retrieve and interpret web pages from web based data sources WBDS. These means may e.g. comprise specialized computer software which interprets and executes JavaScript, e.g. a java script engine, it may comprise one or more layout/rendering engines for handling markup content such as HTML, XML, image files and/or the like, and formatting information such as Cascading style sheets (CSS), Extensible Stylesheet Language (ESL) and/or the like.

The web based data sources WBDS may also be known as web servers. So hence, these web pages are accessible over the internet IN and the client or web server comprising the web browser application(s) comprises suitable data communication means for communicating over the internet with e.g. web based data sources WBDS.

A user U (or a web robot) of the client accesses a web page WP1-WPn by means of the web browser WB, e.g. by entering a web address/Uniform Resource locator in the browser that refers to a web page. The web browser WB then retrieves the web page WP1 at the URL, and visualizes the web page on a screen of the client C1, C2. This is preferably done by performing a web page processing of the web page WP1 retrieved from a web based data source WBDS, and establishing an internal browser representation FIR, FUIR of the web page WP1 in the web browser, for example the web page WP1.

This is done by processing the retrieved web page WP1 and parsing the content of the web page into an internal Document Object Model IDOM in the web browser WB. The user can then browse the web page WP1 by means of the browser.

The web page WP1 comprises static content in the form of e.g. a markup language content and style sheet content. The markup language content may be written in any suitable markup language, however it is often Hypertext Markup Language (HTML).

The style sheet content may comprise cascading style sheets (CSS) that comprises information regarding how the markup language content should be visually be presented to the user on the screen of the client C1, C2.

Moreover, most web pages comprise dynamic content in the form of e.g. scripting content such as JavaScript content or similar. This scripting content may change the behaviour of a web page in response to mouse or keyboard actions or other actions performed by the user and/or by the web page itself. The dynamic content may comprise client side scripting and/or means for facilitating server side scripting.

The dynamic and “static” content of the web page is processed by the web browser and results in the above mentioned resulting first internal browser state representation FIR in the web browser by means of among others an internal Document Object Model representation IDOM in the web browser WB. The internal Document Object Model representation IDOM may also referred to as “internal DOM” in the following.

The internal DOM is however modified over time due to actions performed by the user U, and/or due to scripting content that automatically modifies the web page representation by means of the IDOM. So the internal DOM IDOM which is established at different clients but based on the same web pages WP may look different due to different user interactions with the web page and/or that the scripting of the web page varies over time so that a web page presented at different times look and/or acts different. Hence, when establishing a state representation of a web page WP1-WPn represented in a web browser WB according to embodiments of the presently disclosed inventive concepts, it may be necessary to take this into account. According to embodiments of the presently disclosed inventive concepts, this may be achieved by e.g. the following.

The user U (or a web robot) may wish to facilitate to continue from a specific state of the first internal representation of the web page WP1 in another web browser (WBA) or the same web browser at a later point in time. According the embodiments of the presently disclosed inventive concepts, the user U (or web robot) then initiates establishing and storing of an external representation ER of the state of the first internal representation FIR at a point during the web page processing. This may be performed by clicking a button on the screen of the client by means of a computer mouse or touching a touch screen at a specific location, entering a command by means of a keyboard and/or the like

A web robot may be defined as a software application running automated tasks over the Internet. Typically, wet robots perform tasks at a much higher rate than would be possible for a human alone. The web robot comprises a predefined set of rules and/or instructions that may be designed so as to access, process and retrieve content from a specific web page or certain types of web pages. Hence, the robot may be designed, when implemented and running, to access a web page by means of a browser, and retrieve the data from the web page to e.g. store and/or index the content of a database accessible through the web page, to perform an analysis of the content of the web page (or a database accessible by means of the web page) or the like. The robot may thus be constructed based on a web page or certain types of web pages by a user so that the robot will be able to automatically access the web page and access the data intended to he accessed by the user designing the robot.

The web robot may hence be designed so that when specific criteria is complied with in the browser, e.g. that a specific state of the browser is reached, the robot initiates an establishing of an external representation, For example, when scripts of the web page has been executed, and the web page has been processed so that data required by the robot is accessible, an external representation may be established so that one or more further internal representations in (an)other web browser(s) can be established, or so that the robot may return to an internal representation later on that is at a state corresponding to the browser state at the time of the establishing of the external representation. This is moreover described later on in this document

In the event of using web robots according to embodiments of the presently disclosed inventive concepts, the web robot may be configured to operate according to a set of rules where, when a set of criteria is complied with and/or a, to the web browser, predefined state of the browser has been reached, one or more web robot API methods may be called so as to establish the external representation ER as described in different embodiments of the presently disclosed inventive concepts and/or to process web page data The robot(s) may thus in aspects of the presently disclosed inventive concepts utilize different conventional methods so as to navigate through the web page(s), but may moreover comprise an integrated functionality enabling the robot to establish external representations as disclosed in different embodiments of the present document. The robot(s) may thus be able to e.g. load web pages, extract URL information, extract images, extract text etc. by means of a web browser.

The initiation of the establishing of an external representation ER initiates processing of the internal DOM representation IDOM of the web browser WB so as to establish an external representation ER comprising a representation RFC of first content FC of the first internal representation FIR. The first content FC comprises e.g. an internal browser representation of markup content and an internal browser representation of style sheet content. ft may furthermore, in embodiments, comprise an internal browser representation of cookies and/or an internal browser representation of form content relating the presented web page in the web browser.

Moreover, an external dynamic content state representation DCSR which represents the state of the dynamic content DC of the first internal representation (FIR) is established. The establishing of the above mentioned external representation of dynamic content state DCSR and the first content RFC may comprise a processing of the respective internal representation and converting the content into a predetermined data format.

For example, the markup content of the internal browser representation may be stored in an external representation in a markup language format such as Extensible Markup Language (XML) or similar.

The style sheet content may be stored in a style sheet format such as cascading style sheet (CSS) or similar.

The cookie information may be stored in a text document or similar comprising a text string representing the cookie, and the form content may also be stored in a document format such as a markup language, e.g. XML.

The representation of the dynamic content may be stored in a binary format, and contains the state of the dynamic content, and preferably also the dynamic content itself.

It is generally understood that the external representation in embodiments of the presently disclosed inventive concepts may be established external to the web browser. Hence, it may be stored at a data memory of the client C1 (explained in more details later on) it may be stored at a data storage external to the client C1 and/or the like.

Moreover, the first internal state representation FIR may comprise a plurality of pointers from the dynamic content to the computer memory addresses containing values of variables of the markup language content and/or style sheet content of the internal representation. These pointers may be necessary to map so as to facilitate establishing of a corresponding browser state in another web browser application WBA. Therefore, according to the presently disclosed inventive concepts, mapping data MD comprising mapping of relationships between the dynamic content DC and at least a part of the first content FI such as the markup language content of the first internal representation FIR is established. This mapping data MD hence comprises information relating to how the dynamic content DC and first (static) content FC of the first internal representation FIR. was related, and hence how the corresponding content should be related in the further internal representation FUIR.

The external representation ER is stored at a data storage either at the client C1, at a web server external to the client or at any other appropriate location. The external representation ER may even be copied into a plurality of external representations (not illustrated in FIG. 1) and each of these may be used for establishing one or more further internal representations in a plurality of web browser applications WBR.

The external representation(s) ER may thus be used (as described in more details later on) for building a further internal browser representation FUIR of a web browser application WBA at a state corresponding to the first internal state of the web browser WB.

According to embodiments of the presently disclosed inventive concepts, the external representation is processed and a further internal DOM representation FIDOM is established in the web browser application WBA based thereon. This is performed by processing the external representation ER in the form of the external representation RFC of the first content FC, the external dynamic content state representation DCSR and the mapping data.

A user may then, when the further internal browser representation FUIR in the web browser application WBA is established, continue to browse the web page WP from a state corresponding to the state of the first internal representation.

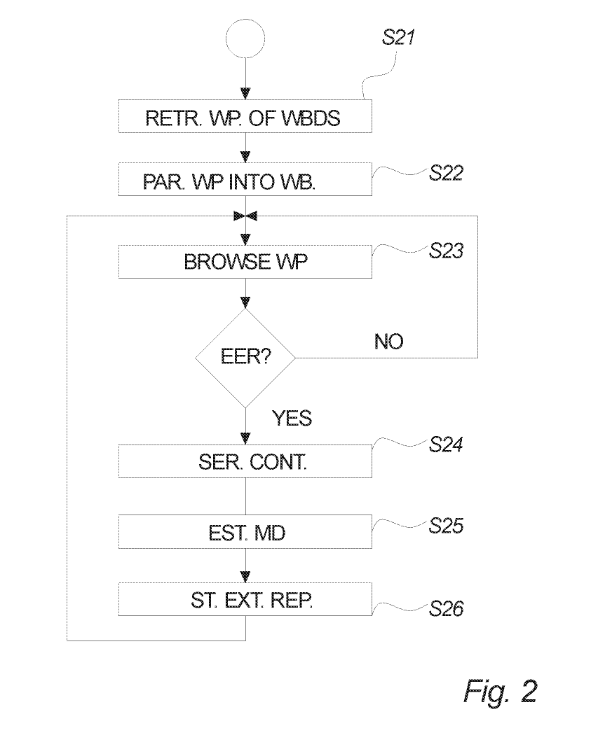

FIG. 2 illustrates a flow chart relating to an embodiment of establishing an external ER representation according to embodiments of the presently disclosed inventive concepts.

At step 21 (RETR. WP. OF WBDS), the web browser retrieves a web page WP from a web based data source WBDS. E.g. due to that a user enters an URL in the browser or activates a link in the browser or a hyperlink in a document.

In step 22 (PAR. WP IN WB.), the browser processes the retrieved web page and parses the web page into an internal DOM representation of the web browser WB.

The user U can now browse the web page WP (Step S23) by clicking links and tabs of the web page, the user U may enter form content of the web page and the like. At a point during the browsing of the web page WP, the user U, may wish to establish a state of the web browser WB in another browser or in a tab of the same web browser.

Therefore, the user U may initiate the establishing of an external representation ER as described above. The browser (or another tool) hence externalizes the state of the browser WB. This is facilitated by serializing the internal state representation of the web browser into one or more external representations that together represents the state of the browser (Step S24). The browser WB hence serializes the first content FC of the internal representation FIR into an external representation ER. The serializing comprises converting the data structure of the internal representation FIR into a format to be stored in a file or the like in a data memory. Alternatively, the serialized content may in aspects be transmitted immediately to be used in connection with establishing a further internal representation FUIR in another web browser application or tab without an intermediate storing of the externalized data.

The serializing preferably also comprises obtaining the values of the objects of the internal representation in the external representation ER at the time of establishing the external representation ER.

The objects represent a piece of data and are normally assigned a value at the memory location assigned to the object. This/these values are preferably copied to the external representation ER so as to be reinserted in a further internal representation later on.

The serialized content can then be re-established later on at the same client C or at another client or web server.

The internal representation FIR is moreover processed (Step S25) so as to determine references/relations between the dynamic content DC and the first content FC of the internal representation FIR. This is performed by establishing mapping data MD. The mapping data MD may in preferred embodiments of the presently disclosed inventive concepts comprise information relating to mapping of pointers or references to memory addresses of variables used in the first internal state representation FIR of the web browser WB at the client C1 or web server as described in more details later on. In this way, it is possible to determine the relations/references between the dynamic content DC and the first content FC such as markup language related content and/or style sheet related content of the internal representation FIR.

The externalized data established in connection with steps S24 and S25 is then stored at a data storage 826 for later use in connection with establishing a further internal browser state representation FUIR.

The user can then continue to browse the web page, knowing that it is possible to establishing an earlier state of the web browser, and may furthermore establish further first state representations FIR of the web browser during the further browsing of the web page.

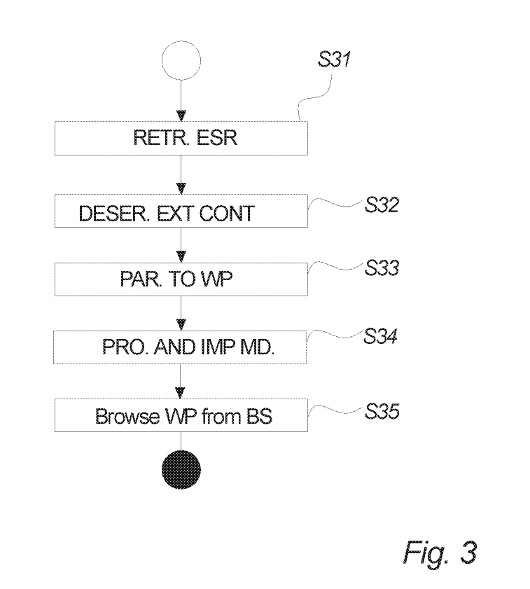

FIG. 3 illustrates a flow chart relating to an embodiment of establishing a further internal state representation FUIR in a web browser based on an external representation ER according to embodiments of the presently disclosed inventive concepts.

At step S31, an external representation ER representing a previous state of the web browser WB is retrieved.

In step S32, at least a part of the external representation ER is deserialized and converted to a format that a parser of the web browser WBA that is intended for the further internal representation, is able to parse (step S33) into a further internal Document Object Model FIDOM of the web browser WBA.

The values of the objects that was present at the time of the externalisazion of the first internal representation FIR is preferably also read into the further internal representation FUIR.

In step 34 (PRO. AND IMP MD.), mapping data MD of the external representation ER is processed and implemented to finish the reestablishing the state of the first internal representation FIR. Hereby, the relations between the dynamic content DC and the first content FC in the further internal representation FUIR, which is based on the information of the external representation ER, is reestablished. This may e.g. comprise establishing and/or correcting pointers so that pointers between the dynamic content DC and first content FC of the further internal representation FUIR are set to substantially correspond to the pointers of the first internal representation FIR. However, with the difference that the pointers/references of the further internal representation FUIR are set to point to other memory addresses compared to the memory addresses of the first internal representation FIR.

In step 35 (Browse WP from BS), a user, a web robot and/or the like may hence use the further internal representation MIR to browse the web page WP from a browser state corresponding to state of the first internal representation FIR.

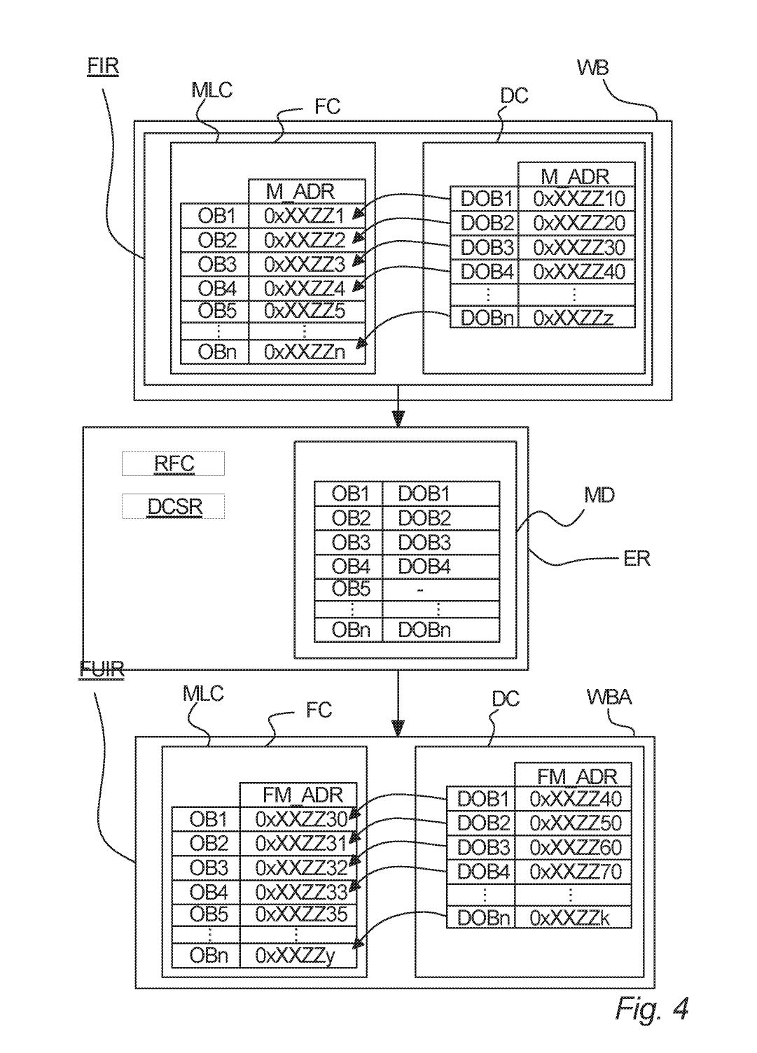

FIG. 4 illustrates schematically an embodiment of mapping pointers according to embodiments of the presently disclosed inventive concepts.

The first internal representation FIR of the web browser WB comprises a plurality Of references in the form of pointers between objects DOB1-DOBn of the dynamic content to memory addresses M_ADR containing values of objects OB1-OBn of the first content FC of the first internal representation of the web browser WB.

These objects and pointers of the dynamic content are represented in an internal binary representation by a JavaScript engine. This java scripting engine may be implemented in a programming language, such as e.g. C++ or the like, which operates with references in the form of pointers which are data types whose value refers/points directly to another value stored elsewhere in the computer memory using its memory address.

The objects DOB1-DOBn of the dynamic content may be scripting objects such as JavaScript objects or other types of objects. These objects are naturally located. at other memory addresses (0xXXZZ10-0x.XXZZz) than the objects of the first content OB1-OBn (these are allocated in the memory at 0xXXZZ1-0xXXZZn) in the present example.

The first content FC in this embodiment comprises Markup Language content of the first internal representation. The markup language content MLC is preferably content that has been established during a parsing of the Markup Language part, e.g, HTML content of the web page WP into the web browser WB. The first content FC may however also in further embodiments comprise style sheet content that has been established during the parsing of the web page into the web browser WB.

As indicated by arrows, the first object DOB1 of the dynamic content points/refers to the memory address 0xXXZZ1 and hereby obtains the value of the first object OB1 of the first content FC, the second object DOB2 of the dynamic content points/refers to the memory address 0xXXZZ2 and hereby obtains the value of the second object OB2 of the first content FC and so on. It is noted that there is no pointer from the dynamic content to the fifth object OB5 of the first content FC. It may however in embodiments be advantageous to process this object also to “tag” it with the purpose of enabling establishment of a corresponding object in a further internal representation. The memory location assigned to of such objects in the further internal representation may however not necessarily be important.

Now, when an external representation ER is to be established as described above, the above mentioned relations in the form of pointers are mapped, This is preferably done by processing the dynamic content of the internal representation FIR so as to identify pointers between objects DOB1-DOBn of the dynamic content and objects OB1-OBn of markup language content MLC. If a pointer is identified, the object OB1-OBn having a value at the respective memory address M_ADR is identified, and the mapping data MD is hence established so as to contain information.

The mapping data MD of the external representation ER will hence comprise the information that the first object DOB1 of the dynamic content DC pointed towards the memory address of the first object OBJ1 of the first content FC, that the second object DOB2 of the dynamic content DC pointed towards the memory address of the second object OBJ2 of the first content FC and so on. Moreover, the objects of the first content and the second content are preferably tagged with an identifier during serializing so as to enable identification of the Objects later on during implementation of the further internal representation FUIR. This may be done during e.g. the serializing as explained in more details later on.

Now, upon establishing the further internal representation FUIR, the representations of the first content RFC and the dynamic content DCSR of the external representation is implemented into the web browser application WBR. This is preferably done by &serializing and parsing at least a part of the representations RFC, DCSR into the Internal DOM of the web browser application, and it may also comprise implementing further content such as e.g. browsing history data, cookie data, form data and/or the like (not illustrated in FIG. 4) extracted from the first internal representation FIR during establishment of the external representation.

During this, memory of the necessary objects OB1-OBn DOB1-DOBn of the first content and dynamic content of the first representation FIR will be allocated at memory addresses FM_ADR of a data memory of the client (not illustrated in FIG. 4) comprising the web browser application WBA for the further internal representation FUIR. These memory addresses FM_ADR will most likely be different from the addresses M_{———}ADR of the first internal representation FIR as indicated.

The first object OB1 of the first content FC is hence allocated at the memory address 0xXXZZ30, the second object OB2 of the first content FC is allocated the memory address 0xXXZZ31 and so on. The first object DOB1 of the dynamic content is allocated at the memory address 0xXXZZ40, the second object DOB2 of the dynamic content is allocated the memory address 0xXXZZ50 and so on.

After this, the mapping data MD is processed. Based on this mapping data, pointers between the dynamic content DC and the markup language content MC is re-established. This implementation of the mapped data relating to relations/pointers between objects is performed after an initial parsing of the content of the external representation ER representing the dynamic content and the markup language and style sheet content of the first internal representation. This is because, after this parsing, the memory of the objects is allocated, and thus it is possible to reestablish the pointers to the correct memory addresses that are used for the further internal representation.

For example, the mapping data comprises the information that the first object DOB1 of the dynamic content should point towards the memory address of the first object OB1. Hence, the memory address of the first object OB1 is identified (which in this case is 0xXXZZ30), and a pointer is then established between the first object DOB1 of the dynamic content and this memory address. A corresponding processing is performed for the remaining objects DOB2-DOBn) so as to establishing pointers corresponding to the pointers of the first representation FIR, however with a memory address being based on the memory addresses of the further internal representation after the deserializing and parsing into the web browser application WBA.

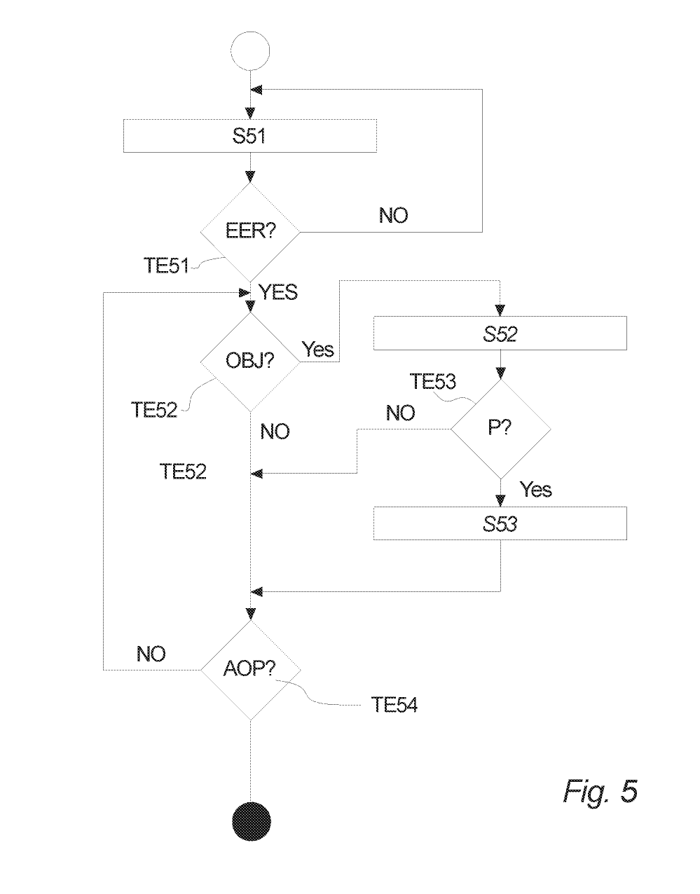

FIG. 5 illustrates an embodiment of establishing an external representation by identifying pointers and tagging objects.

In step S51, a user U or a web robot browses a home page. At a point, the user U or web robot wishes to establish an external representation ER (EER=Establish External Representation). This initiates serializing process comprising a number of steps if the test TE51 (EER?) is positive in the sense that an external representation of the browser state should be established.

The web browser WB hence starts to serialize markup language content and dynamic content DC of the first internal representation FIR. This is achieved by processing the internal DOM MOM of the web browser by identifying objects of the internal representation (Test TE52 (OUJ?)) and their relations. If an object is identified, it is tagged with the purpose of later identification (Step S52), its value at the corresponding memory address(s) is copied and the like.

Moreover, if an objects of the dynamic content (DOB1-DOBn of FIG. 4) of the first internal representation FIR is identified, it is tested (test TE53 (P?)) whether it comprises a pointer to another memory address of the first content FC. If it does, step S53 is initiated where the object of the first content (FC) having the memory address that is pointed/referred to is identified and mapped so that the mapping data MD comprises the information of that a relation in the form of a pointer or reference should be established from the respective object of the dynamic content DC to the object of the first content FC. This information may in embodiments of the presently disclosed inventive concepts be established based on the tagging of objects during the serialization so as to easily identify the respective objects later on. Then, the web browser continues to identify objects as described above to identify objects and establish external representations of the dynamic content DC and first content FC. If the object does not comprise a pointer (TE53), the web browser continues to identify further objects (TE52)

This is done, until all relevant objects of the objects (DOB1-DOBn) of the dynamic content DC of the first internal representation FIR and the first content have been processed (test TE54 tests if all relevant objects have been processed (AOP?)).

During the processing in steps S52 and S53, an external representation ER of the internal document object model IDOM is established so that the resulting representation ER comprises data corresponding to the internal DOM structure(s) of the web browsers. This may be facilitated by creating a XML representation by means of e.g. xpath during the processing of the objects.

The external representation now moreover comprises mapping data MD that comprise information of references/pointers between objects in the first internal representation FIR at the time when the external representation is established., and data representing the markup language content MLC of the first internal representation FIR in the web browser.

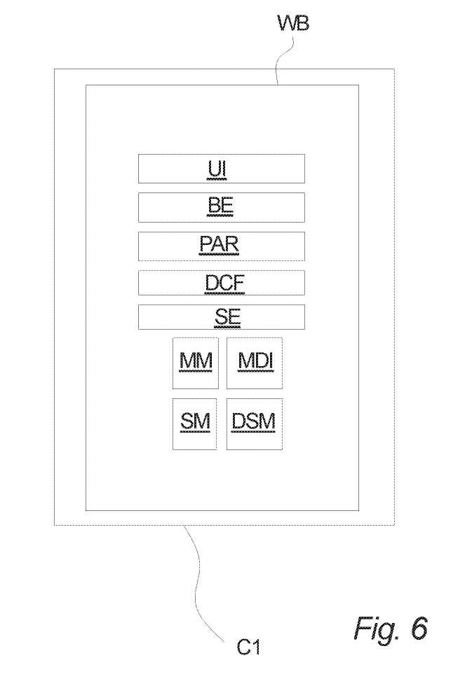

FIG. 6 illustrates a web browser according to embodiments of the presently disclosed inventive concepts facilitating establishment of an external representation ER. and implementation of an external representation ER to establish a further internal representation.

The web browser WB comprises ordinary browser means such as e.g. parser means PAR for parsing a web document into an internal representation in an internal DOM (Document Object Model) IDOM representation (not illustrated). During this parsing, objects are allocated in the internal IDOM. The web browser WB moreover comprises other conventional functionalities such as a user interface UI, a browser engine BE, a data communication facility DCF for facilitating that the web browser WB can receive and transmit data from/to web servers and/or the like, and a scripting engine SE, such as a JavaScript engine, which is used to parse and execute scripting (e.g. JavaScript) of a home page.

Moreover, the web browser comprises serializing means SM for serializing an internal representation as described above. Also, the web browser (WB) comprises deserializing means/arrangement DSM for deserializing an external representation ER as described above.

Additionally, the web browser comprises mapping means MM for mapping relations between objects in the internal representation FIR and establishing mapping data MD as described above.

Also, the web browser may comprise a mapping data interpreter MDI facility for implementing the mapping data in a further internal representation FUIR.

In further embodiments of the presently disclosed inventive concepts, the deserializing means DSM and mapping data interpreter MDI may be omitted if the web browser WB is only configured for establishing the external representation(s) ER (not illustrated in FIG. 6) and not for creating a further internal representation FUIR.

Moreover, in embodiments of the presently disclosed inventive concepts, the serializing means SM and mapping means MM may be omitted if the web browser WB is only configured. for establishing a further internal representation FUIR based on a pre-established external representation(s) ER (not illustrated in FIG. 6) which is/are established by another web browser.

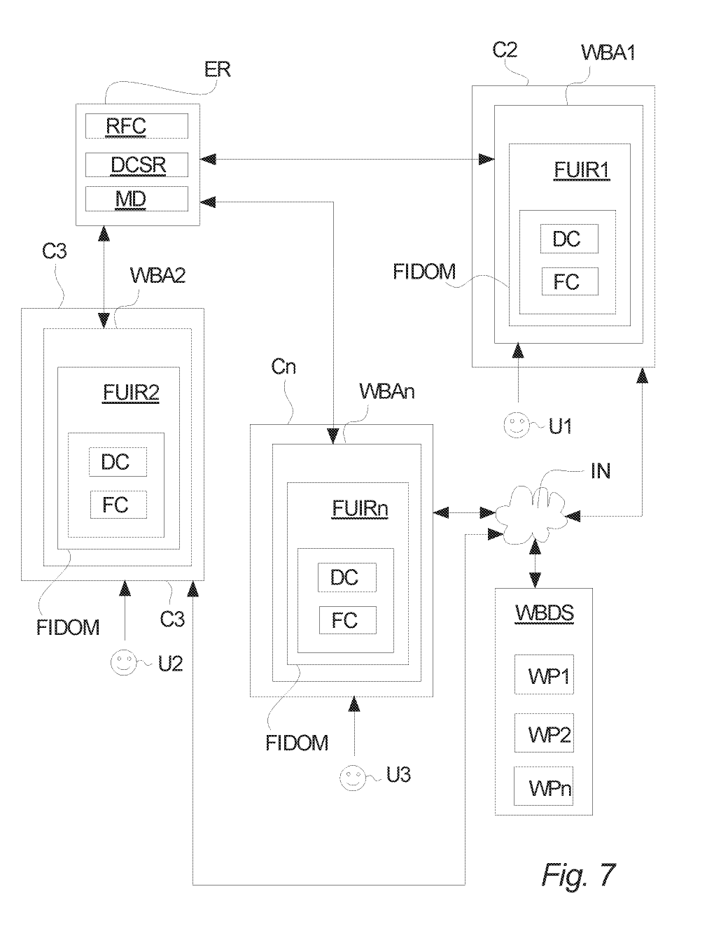

FIG. 7 illustrates an embodiment of the presently disclosed inventive concepts relating to establishing a plurality of further internal state representations FUIR1-FUIRn based on one pre-established external representation ER of a state of a first internal representation FIR (not illustrated in FIG. 7).

The external representation ER may have been established as described above. The external representation is used to establish a plurality of further internal state representations FUIR1-FUIRn at different clients C2-Cn. Each of these clients C2-Cn hence comprises a web browser application WBA1-WBAn which, when the further internal representation FUIR is established based on the external representation ER, may be used for individually accessing the web page of a web based data source WBDS that was represented in the first internal representation FIR (not illustrated in FIG. 7), as described in relation to e.g. FIG. 1. Different individual users U1-U3 (or web robots) may hence access the web page from a state corresponding to the first internal representation FIR.

The web browser applications WBA1-WBAn hence individually establishes a browser state representation FUIR1-FUTRn corresponding to a state of the first internal representation FIR (not illustrated in FIG. 7) based on the external representation ER.

In an embodiment of the presently disclosed inventive concepts which is not illustrated, a client C1-Cn may comprise two or more web browser applications for each their individual further internal representation FUIR.

In further embodiments of the presently disclosed inventive concepts which is not illustrated, a client C1-Cn may comprise one web browser application comprising two or more individual further internal representation FUIR. This may be facilitated by a web browser application that comprises a “tab functionality” where one web browser can browse several web pages (or sub pages of one web page) in different tabs of the web browser WB.

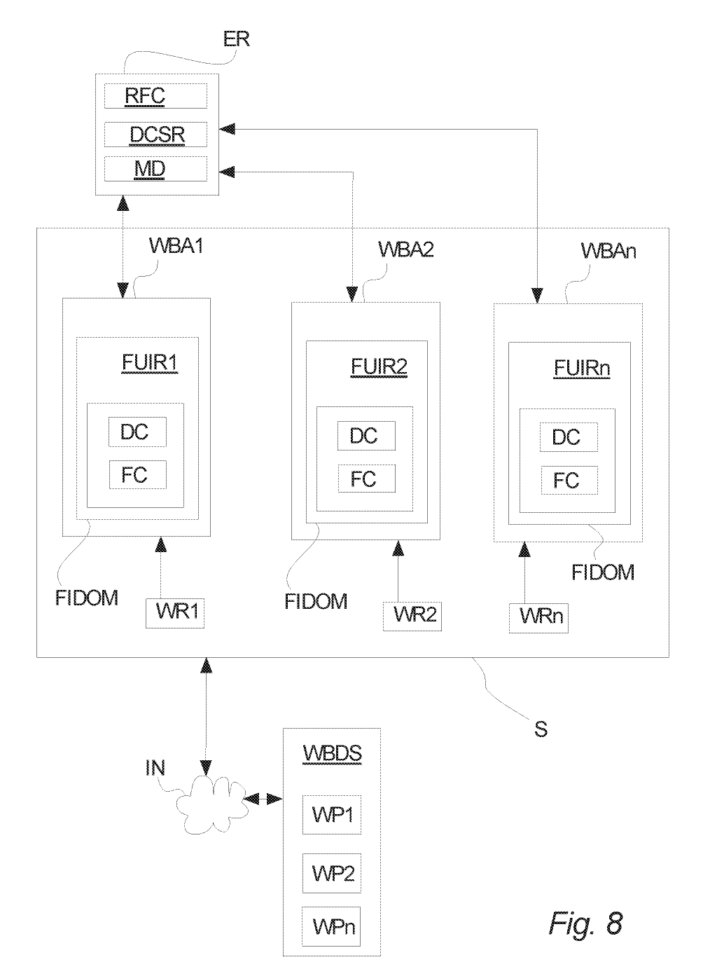

FIG. 8 illustrates a further embodiment of the presently disclosed inventive concepts relating to establishing a plurality of further internal state representations FUIR1-FUIRn based on one pre-established external representation ER.

In this embodiment, a plurality of further internal representations of a first internal representation is established in web browser applications WBA1-WBAn located at a server S. The server S is connected to the internet IN so that the individual web browser application WBA1-WBAn may access the respective web page from a state corresponding to astute of the first internal representation FIR (not illustrated in FIG. 8) after the internal representation is established.

The web browser applications WBA1-WBAn hence individually establishes a browser state representation FUR1-FUIRn corresponding to a state of the first internal representation FIR (not illustrated in FIG. 8) based on the external representation ER.

A plurality of individual web robots WR1-WRn and/or users may hence browse a web page from the state corresponding to a state of the first internal representation FIR, by means of individual web browser applications at the web server.

It is understood that in embodiments, the web browser applications WBA1-WBAn may be distributed between two or more different servers S (not illustrated in FIG. 8).

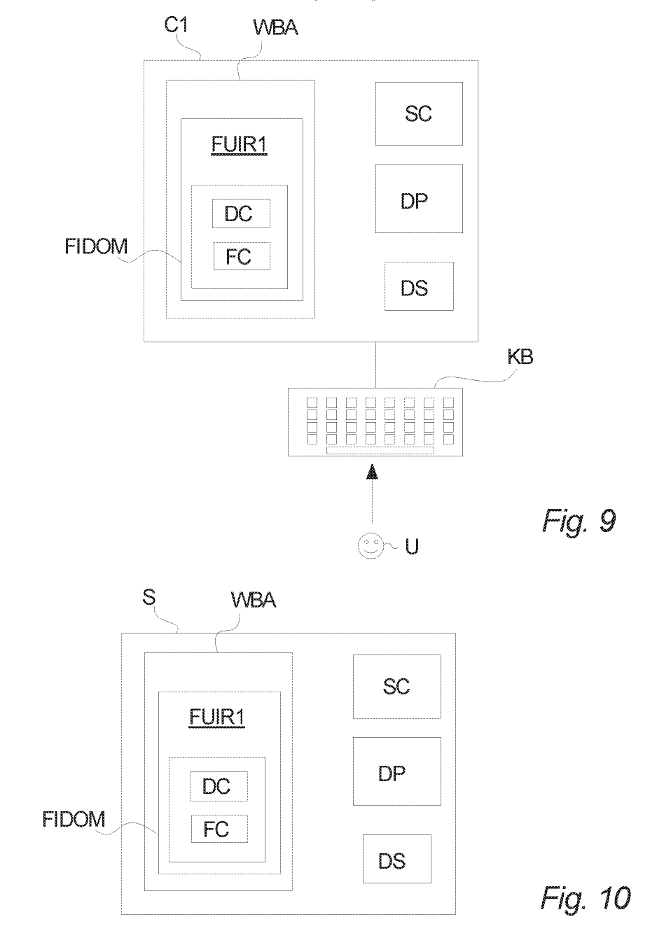

FIG. 9 illustrates a client C1 (or a server) comprising means according to embodiments of the presently disclosed inventive concepts, The client may be used for establishing and externalizing the first internal representation FIR as described above in relation to e.g. FIGS. 1, 2, 4 and 5 and/or establishing a further internal state representation FUIR as described in relation to e.g. FIGS. 1, 3, 4 and 5.

The client C1 comprises a screen SC allowing a user U to see what is visualized by the web browser application WB, WBA installed at the client C1. Moreover, the client C1 comprises one or more data processors DP for processing data according to instructions. The data processor DP may also be referred to as a central processing unit CPU.

Additionally, the client C1 comprises one or more data storages DS. This data storage(s) DS is used to store the web browser and data generated by the web browser application WBA such as the first internal representation FIR and/or further internal representation(s) MIR. The data storage DS may comprise a Random Access Memory (RAM) a Hard Disk Drive HDD and/or Solid-State Drive and/or the like.

The client C1 moreover comprises a keyboard KB for allowing a user U to browse the internet by means of the client C1. In aspects where the screen is a touch screen, the keyboard may be a software keyboard application installed at the client C1 and accessed by the user U

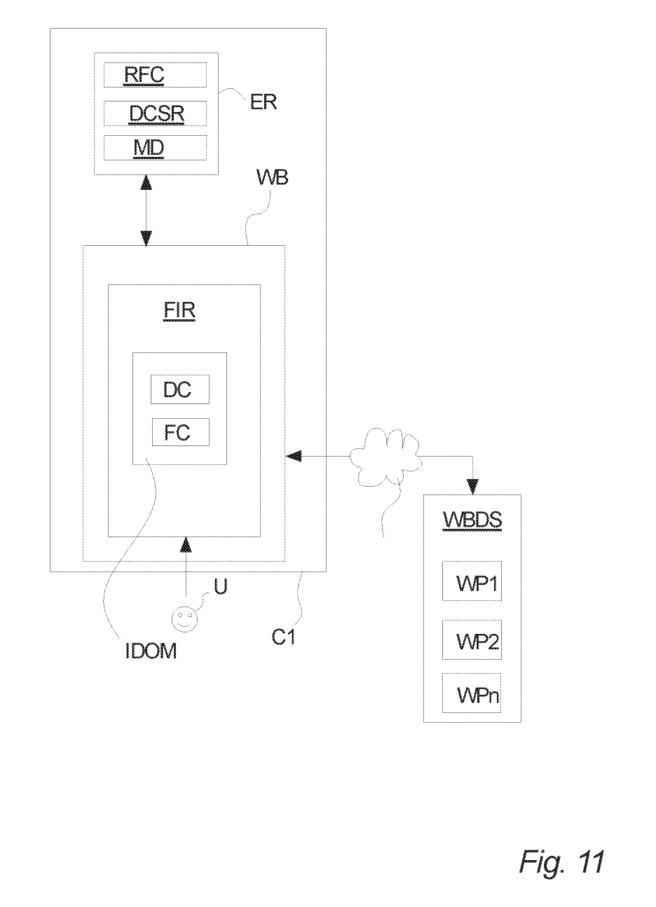

FIG. 10 illustrates embodiments of a server S according to embodiments of the presently disclosed inventive concepts. The server S comprises one or more data processors DP for processing data according to instructions. The data processor(s) DP may also be referred to as a central processing unit CPU. Additionally, the server WS comprises one or more data storages DS. This/these data storage(s) DS is/are used to store one or more web browser application(s) WBA and it may also be used for storing data generated by the web browser application WBA such as an external representation ER of the first internal representation FIR (not illustrated) and/or further internal representation(s) FUIR generated in the web browser application(s). The data storage DS may comprise a Random Access Memory (RAM) a Hard Disk Drive HDD and/or Solid-State Drive and/or the like, It is understood that the data processor DP, data storage DS,

In further embodiments, the server S may comprise a plurality of web browser applications WBA which are operated/manipulated by server executed web robots (not illustrated), see embodiments of FIG. 8 and Figures later on.

Additionally, the server S may comprise the web browser WB comprising the first internal representation, and the means for establishing the external representation. It us generally understood that in aspects of the presently disclosed inventive concepts where the web server comprises a plurality of web browsers web browser applications, a plurality of these may comprise means for generating external representations ER during browsing as defined in this document, e.g. triggered by server implemented web robots as described in this document.

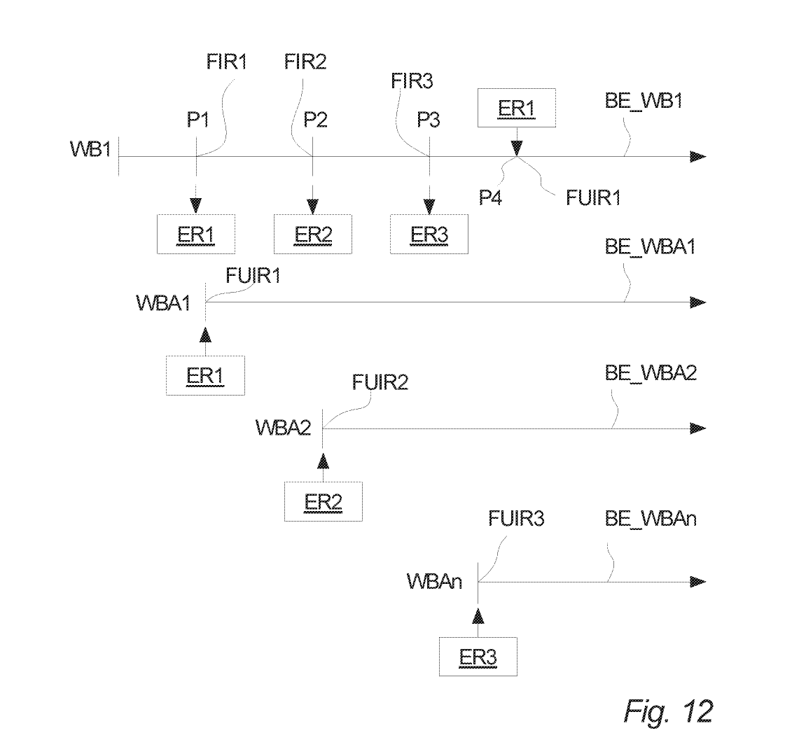

FIG. 11 illustrates an embodiment of the presently disclosed inventive concepts wherein an external representation ER is stored at a data storage at a client C1 comprising the web browser WB that includes the first internal representation FIR. The external representation ER may then at a later point in time be used for restoring the web browser WB to a browser state corresponding to the first internal state of the web browser by deserializing and implementing the content of the external state representation ER into the web browser WB to establish a further internal state representation FUIR (not illustrated in FIG. 10).

The external representation ER may also alternatively be stored at a web server or another server as described in relation to FIG. 8, where the external representation ER may be shared by several web browser applications or alternatively an external representation may be stored for each web browser WB, but the external representations may represent the same first internal representation FIR.

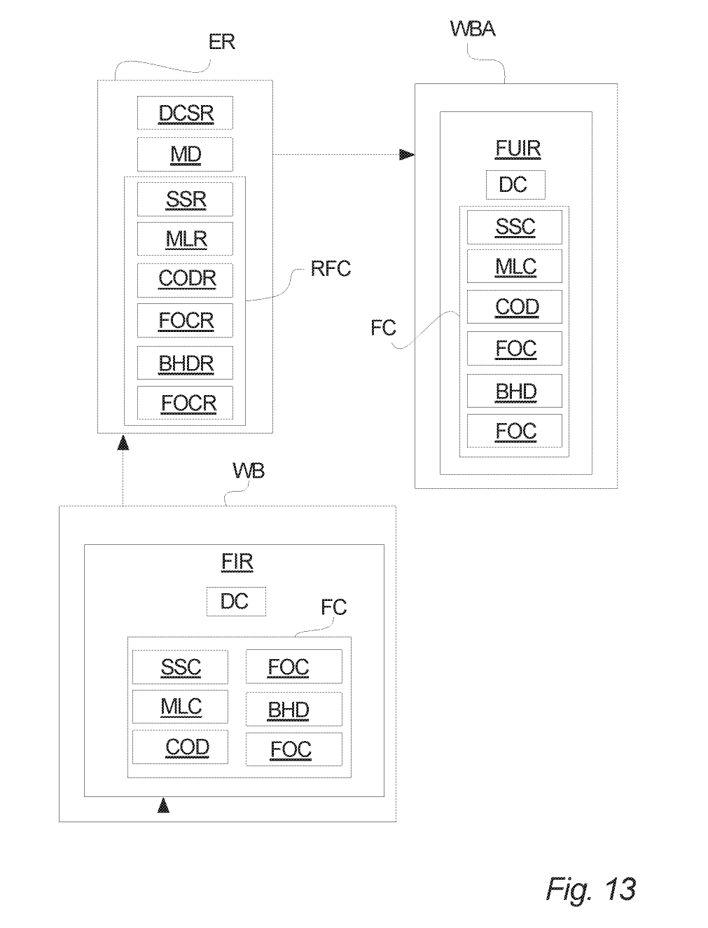

FIG. 12 illustrates an embodiment of the presently disclosed inventive concepts relating to the use of a plurality of external representations ER1-ER3 where the external representations ER1-ER3 represent different first internal browser representations FIR. FIG. 12 discloses four browsing events BE_WR1, BE_WBA1, BE_WBA2, BE_WBAn. These browsing events relates to browsing a web page of an external web based data source, e.g. as disclosed in connection with the above description.

A first browser WB1 is used by a web robot or a user (not illustrated in FIG. 12) for browsing a web page. During the browsing BE_WB1 of the web page, the user or web robot wishes to establish an external representation ER1 at a first point P1 during the browsing event BE_WB1 so as to facilitate re-establishing this first internal browser state FIR1 at the later point. The first internal representation FIR1 hence represents the specific state of the web browser WB1 during the specific browsing event BE_WB1 at that the point P1. The user or web robot hence initiate establishment of a first external representation ER1 representing the first internal representation of the browser state at the point P1.

The user or web robot then continues to browse the web page knowing that the previous first internal representation FIR1 can be restored later on.

The user or web robot may hence establish further external representation ER2, ER3 at the points P2, P3 during the browsing event BE1_WB1, and each of these may hence be used later on for establishing further first internal representations FUIR2, FUIR3 of the state of the web browser WB1 at the points P2, P3. The further external representations ER2, ER3 hence represents the state of further first internal state representations FIR2. FIR3 of the web browser WB1, which is established at a later point during the browsing event BE_WB1.

At the point P4, the user or web browser wishes to re-establish the previous first internal browser state FIR1 to browse the web page from a previous browser state FIR1. The web browser, as a response to user or web robot instructions hence processes the external representation ER1 of the first internal browser state FIR1, and the web browser is hence restored to a browser state FUIR1 at the point P4 from where the user or web robot can then continue the browsing event BE_WB1 at a browser state corresponding to the first internal representation FIR1. This may be facilitated by implementing the external representation ER1 as described above in the previous embodiments by e.g. deserializing and using mapping data as described in connection with e.g. FIGS. 1, 3 and 4. This latter scenario may also be called looping.

In embodiments of the presently disclosed inventive concepts, another web browser application WBA1 is used for initiating a further individual browsing event BE_WBA1 from a browser state corresponding to the first internal browser state FIR1 of the first web browser WB1. Si a further internal representation FUIR1 is thus established by processing the external representation ER1. This may also be achieved as described previously in this document.

In the same way, further internal browser state representations FUIR2, FUIR3 may be established by means of the second and third representations ER2, ER3 respectively, in different further web browser applications WBA2, WBAn which correspond to the web browser states FIR2, FIR3 respectively. This hence initiates further individual browsing events BE_WBA2, BE_WBAn from the respective browser states. A looping in these browsers may also be facilitated by re-establishing the web browser states FIR2, FIR3 respectively in the browsing events BE_WBA2, BE_WBA3 respectively.

It is understood that in embodiments of the presently disclosed inventive concepts, a plurality of browsing events BE_WB1, BE_WBA1, BE_WBA2, BE_WBAn may be facilitated by the same web browser application WB, WBA which in embodiments of the presently disclosed inventive concepts may facilitate establishing and handling of a plurality of browsing events.

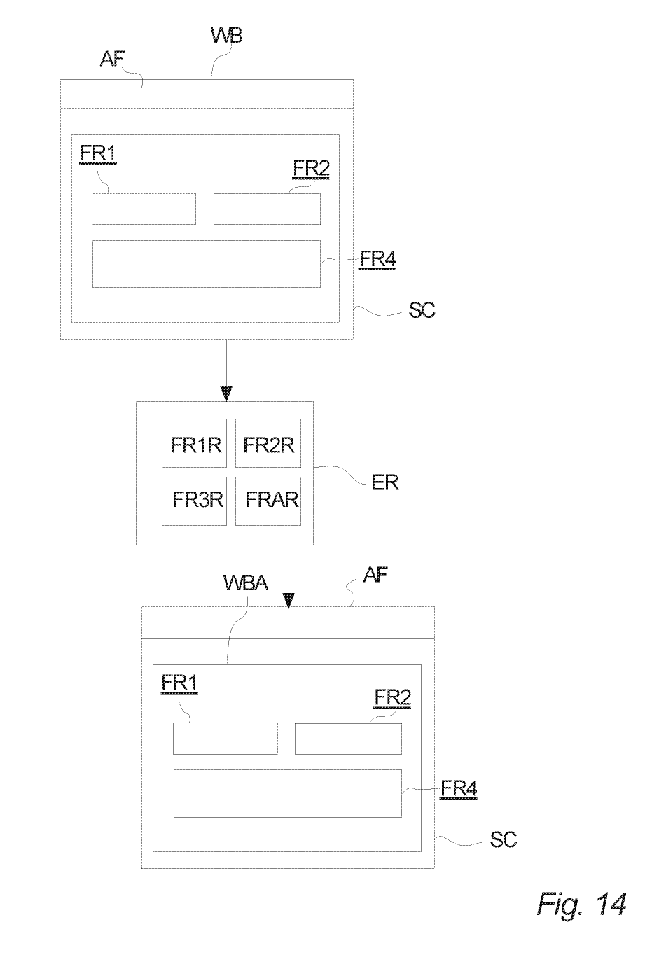

FIG. 13 illustrates an embodiment of an external representation ER and what it may include after the externalising of a first internal state representation FIR.

The external representation ER comprises an external representation DCSR of the dynamic content DC and its state. This external representation DCSR represents the state of the dynamic content DC of a first internal representation FIR of a state of a web browser WB as described previously.

Additionally, the external representation ER comprises mapping data MD describing relationships between the dynamic content DC and at least a part of the first content FC such as the markup language content, style sheet content (or similar content representing a visual layout of the first internal representation FIR.

Moreover, the external representation ER comprises a representation RFC of the state of the first content FC of the first internal representation FIR.

The representation RFC of the state of the first content FC of the first internal representation FIR preferably at least comprises a representation MLR of the Markup language content MLC and may also comprise a representation SSR of the style sheet content SSC of the internal state representation FIR.

The representation RFC of the state of the first content FC of the first internal representation FIR may moreover in embodiments of the presently disclosed inventive concepts comprise cookie information CODR representing cookie data COD of the first internal representation FIR. This data may be identified and copied from the first internal state representation FIR during the establishing of the external browser state representation ER. Hence, the cookies at the first internal representation FIR may be established at a further internal representation FUIR.

In further embodiments of the presently disclosed inventive concepts, the representation RFC of the state of the first content FC of the first internal representation FIR may be established to comprise form content representation FCOR. This form content representation FOCR comprises information relating to form content FOC filled into forms of the first internal representation FIR of a web page.

Moreover, the representation RFC of the state of the first content FC of the first internal representation FIR may in embodiments of the presently disclosed inventive concepts comprise a representation BHDR of browsing history data BHD of the web browser WB at the time of the first internal representation FIR. This representation may be obtained by serializing the browsing history data. Hence, when this browsing history representation BHDR is subsequently implemented in a web browser application WBA, it will enable that the user or web robot can go to previous URLs which were visited during a browsing event that led to the first internal representation FIR. The user may, after establishing of a further internal representation FUIR based on the external representation ER, hence e.g. use a “Back button/function” in the browser application and visit a URL that was visited by the web browser WB before the establishing of the external state representation ER.

It is generally understood that the first content FC and the dynamic content DC may be extracted in any suitable way dependent on the first internal representation FIR. The style sheet content may hence be converted into a cascading style sheet format in the external representation, the markup language content MLC may be converted into e.g. a XML format, the dynamic content DC may be converted or copied into a binary format etc.

It is generally understood that the establishing of the external representation on advantageous embodiments is established based on an internal Document Object Model IDOM representation (not illustrated in FIG. 13) of the web browser WB. This internal Document Object Model represents the state of the browser WB at the time of establishing the external representation ER.

The web browser WB may generally comprise a software code (not illustrated) that enables establishment of the external representation(s) ER by identifying and if necessary serializing the relevant parts of the internal representation FIR. Thus, the software code may be implemented so that when a user or web robot initiates establishment of an external representation ER, the software code may process the internal DOM, dynamic content DC, markup content MLC, style sheet content SSC, cookie data COD, pointers between dynamic content DC and markup content MLC and/or style sheet content SSC, form data FOC, history data BUD and/or the like.

The software code may in other embodiments be considered as an add on to the web browser, and the web browser (WB) may in such embodiments be adapted to corporate with this software to provide access to internal DOM, dynamic content DC, markup content MLC, style sheet content SSC, cookie data COD, pointers between dynamic content DC and markup content MLC and/or style sheet content SSC, form data FOC, history data BHD and/or the like.

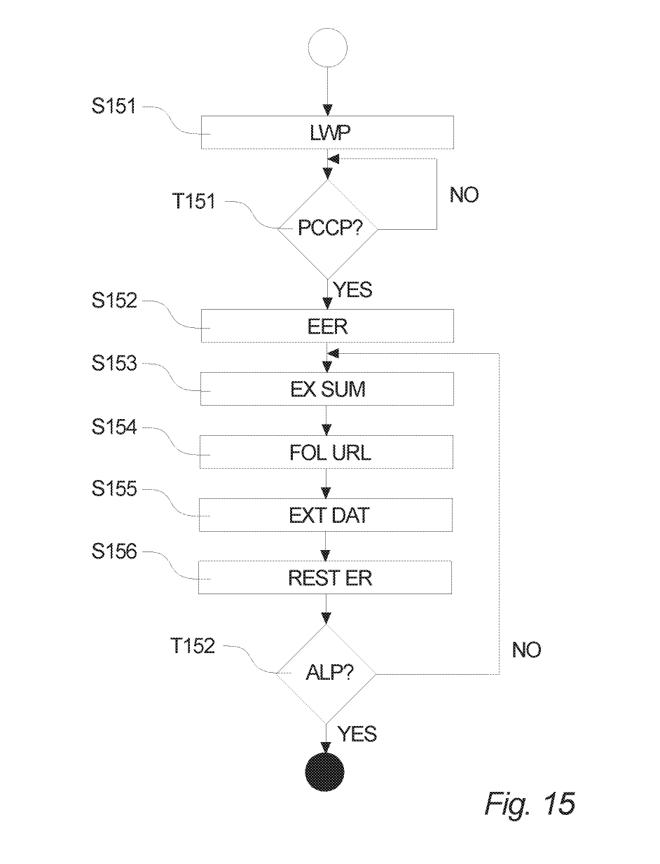

FIG. 14 illustrates an example of a web page visualized on a screen SC by a web browser WB.

The web page comprises a plurality (in this example three) of frames FR1-FR3 (such as inline frames (iframes)). Each frame FR1-FR3 split the web page into different segments which can show a different document/data. A user may enter URL addresses in the address field AF and based thereon, the web browser WB, WBA accesses, retrieves and visualizes a web page of a web based data source.

Each of the frames FR1-FR3 represent different content and comprises their own internal Document Object model structure, Style sheet content and the like in the web browser WB. Hence, an external representation may according to embodiments comprise establishing a plurality of frame representations FR1R-FR3R which represents different frames of the first internal representation FIR of the web page. Each of these may comprise both first content FC and dynamic content DC as described above, and the frame representations FR1R-FR3R hence comprises an external representation ER of the internal state of each frame FR1-FR3 in the web browser.

Moreover, the frames FR1-FR3 are associated in the web browser in a frame tree structure, and this frame tree structure is moreover determined and externalized in the external representation ER as a frame association representation FRAR so as to be able to correctly associate and/or visualize the frames FR1-FR3 later on in a further internal representation FUIR in the same or another web browser as described earlier.

The frame tree and the content of the frames is preferably processed and serialized based on the internal document object model IDOM of the browser WB.

Together with each frame, mapping data MD may be established so as to facilitate a subsequent reestablishment of relations such as pointers between objects and memory addresses of each individual frame and/or between the frames if such exist.

It is generally understood that the web page may comprise one, two, three, four, five or even more frames that should be externalized.

The frames FR1-FR3 may hence be identified by processing the IDOM of the web browser, and the external representation ER may hence in aspects of the presently disclosed inventive concepts be established based on the configuration of the IDOM. For example, the IDOM may determine the number of external representations of markup language Content representations and other parts of each frame.

For example, the web browser may process the Internal DOM and determine that the DOM represents a web page with individual frames FR1-FR3. So hence, three Dynamic content state representations DCSR should be established, and three representations of the first content FC should be established (not illustrated), relating to each their frame. And moreover, a frame three representation/frame association representation FRAR should be established. All this is a part of an external representation which together describes the state of the first internal representation FIR of the web browser WB.

So when later on creating a further internal representation FUIR in a web browser application WBA based on the external representation ER, the resulting visualization of the web page will appear just as it did in the first internal representation.

Alternatively, even if the external representation is not visualized, e.g. due to that a web robot uses the external representation, the further internal representation in the web browser application may be established based on the external representation ER by processing the frame representations FR1R-FR3R and the frame association representation FRAR.

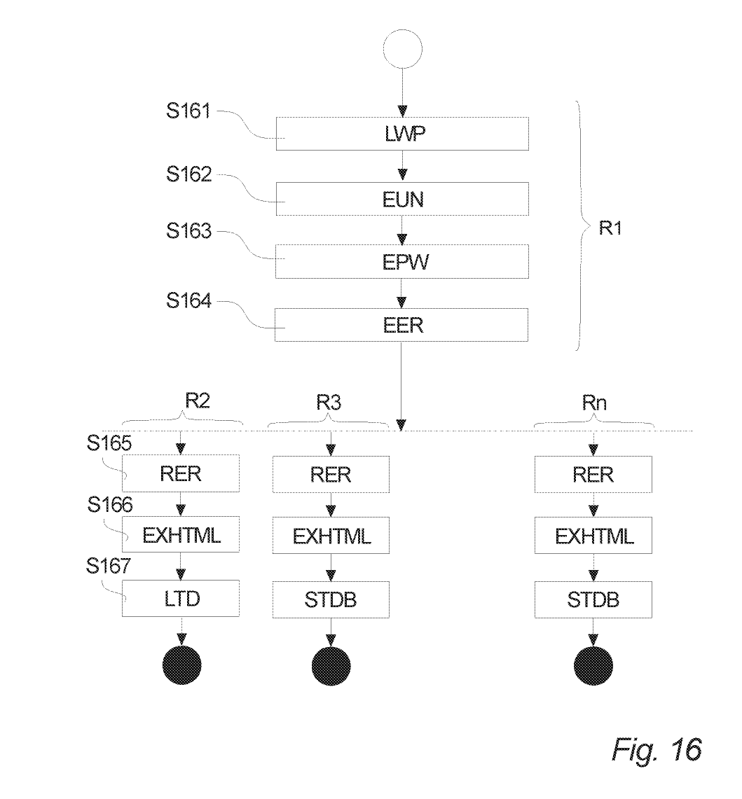

FIG. 15 illustrates an embodiment of the operation of a web robot, e.g. as described previously in this document, where the web robot utilizes an external state representation ER.

In step S151, The web robot, by means of a web browser, loads a web page LWP according to the set of rules and instructions provided to the web robot.

In test T151, the robot tests whether one or more predetermined criteria is/are complied with (PCCP?). These criteria may e.g. comprise a timer which, when expired, allows the robot to proceed, it may comprise surveillance of one or more web page loading parameters such as executed scripting content of the web page in the browser, it may comprise timing factors or any other relevant state indicator that may help to identify when the web page is sufficiently loaded in the web browser.

In step S152, the predetermined criteria have/has been complied with and the robot then initiates establishment/creation of an external representation (EER). This may be done as described in this document, e.g. in relation to any of the FIGS. 1-14.

In step S153, The robot extracts a summary of a Link/URL of the web page represented in the web browser (EX SUM). This may comprise extracting information of a blurb which is considered as a short summary or promotional piece of information that tells what information is to be expected if clicking/activating the related link/URL. This step may be considered as optional.

In step S154, the web robot follows a link/URL by activating the link. If step 153 is a part of the robot, then it is preferably the related. link to the summary that is followed.

In step S155, the robot extracts alternatively indexes) the data of the web page which is processed by the browser when activating the link in step 154.

In step S156, when the data in step 155 has been extracted, the robot restores the web page at the state corresponding to the web page state at step 152. The web robot thus accesses the external representation established at step 152, and this external representation ER is then used to restore the web browser state as it was when establishing the external representation. This may e.g. be done as described in relation to any of FIGS. 1-14.

In test T152, the robot then tests if all (or the wished) links/URLs of the web page have been followed/processed by the robot. So the system/robot hence keeps track of which links/URLs that have been followed/processed by the robot.

If all (or the wished) links/URLs of the web page have not been followed/processed by the robot, the robot starts anew processing given by anew link/URL, e.g. as disclosed in relation to steps 153-156.

If all (or the wished) links/URLs of the web page have been followed/processed by the web robot, the robot may terminate as disclosed in FIG. 15. Alternatively, the robot may continue to process anew web page as disclosed in in FIG. 15, e.g. based on a web page given by one of the links of the above mentioned processed web page, or a new web page.

FIG. 16 illustrates an embodiment of using a plurality of web robots.

In step S161, a web page is loaded (LWP) into a browser so as to be represented in the browser.

In step S162, and 163 a user name (EUN) and a password (EPW) is entered so as to allow access to otherwise restricted data, This may be entered in to a Field in the represented web page which is configured for entering user name (FUN) and password (EPW) an that these can be processed by e.g. clicking/activating a “OK” or “continue” button. (This activation may also in embodiments be facilitated by the robot).

In step S164, establishment/creation of an external representation ER EER is performed. This may be done as described in this document, e.g. in relation to any of the FIGS. 1-15. The external representation ER will thus represent a state of the web browser which includes the pass word and user name. For this purpose, e.g. form data may e.g. advantageously be extracted to be represented as a part of the external representation, if the form data comprises the user name and/or password information. Additionally or alternatively, other information containing the entered password and/or user name information may be retrieved and extracted to the external representation ER.

The steps S161-164 may be performed by a robot R1 as disclosed above. Alternatively, a user may perform the steps S161-164 by manipulating the web browser to retrieve the web page, the user may by means of a keyboard or touch screen or another input facility enter username and password and then manipulate the browser to establish the external representation EER.

Then, a plurality of robots R1-Rn accesses the external representation ER established at step S164 so as the access the content of the previously restricted data, which was restricted due to the need of the user name and password.

Each of the robots R2-Rn thus restores the external representation from step S164 in each their web browser so that the state corresponds to the state of the web browser in step S164. This may be done as disclosed and described in relation to any of the FIGS. 1-15.

The robots thus performs a parallel processing of the web page, preferably by accessing different content of the web page, extracting wanted/wished data such as HTML data (EXHMTL) or any other suitable data from the web pages (Steps 166) and may moreover log the data to a data storage (LTD), store the data in the database (STDB), index the content and/or the like (step S167).

It is understood that in further embodiments, the steps performed by the robots R1-Rn may be combined with and/or substituted with steps S151-156.

It is thus generally understood that the robots described in relation to FIGS. 15 and 16 may be software code comprising one or more sets of rules and/or instructions that may be designed so as to access, process and retrieve content from a specific web page or certain types of web pages as described previously in this document.

It is generally understood that the presently disclosed inventive concepts is not limited to the above examples but may be combined in a multitude of varieties as specified e.g. in the claims. Moreover, it is understood that the embodiments described in relation to FIGS. 1-11 may be used in connection with use of web robots.

Of course, the above descriptions are to be understood as merely demonstrating several exemplary embodiments considered by the inventors to be within the scope of the presently disclosed inventive concepts. Any combination, permutation, variation, or synthesis of the aforementioned features is to be understood as an aspect of the present application, even if the particular combination, permutation, variation, synthesis, etc. is not expressly mentioned in any single embodiment or Figure provided with these descriptions.

Moreover, additional embodiments, variations on the aforementioned embodiments, and alternative embodiments are also to he considered fully within the scope of the present, application, according to the understanding achieved by one having ordinary skill in the art upon reading these descriptions.

Accordingly, the above descriptions should be considered in no way limiting on the scope of the present application. Rather, the subject matter presented herein is offered to illustrate the extent of the present inventive concepts. The metes and bounds of the property rights sought pursuant to this application are to be defined by the following claims and all equivalent forms thereof that a skilled artisan would comprehend upon reviewing the preceding disclosure.

1-48. (canceled)

49. A computer-implemented method of establishing a state representation of a web page represented in a web browser, the method comprising: using the web browser:
conducting a web page processing of a web page retrieved from a web based data source;
establishing a resulting first internal browser state representation of the web page in the web browser;
establishing an external representation; the external representation representing a state of the first internal representation;
wherein the establishing of the external representation of the state comprises:
establishing a representation of a first content of the first internal browser state representation;
establishing a dynamic content state representation which represents the state of the dynamic content of the first internal browser state representation; and
establishing mapping data comprising a mapping of relationships between the dynamic content and the first content; and
making the external representation available to a web browser application so as to establish a further internal representation of the web page in the web browser application at a state corresponding to the state of the first internal browser state representation.

50. The method according to claim 49, wherein the establishing of
the external representation comprises serializing at least a part of the first internal browser state representation; and
wherein the part of the first internal browser state representation comprises at least a portion of one or more of the dynamic content and the first content.

51. The method according to claim 49, wherein at least one of the following provisos are satisfied:
the establishing of the further internal representation comprises deserializing at least a part of the external representation; and
the establishing of the further internal representation comprises parsing at least a part of the external representation into the web browser application.

52. The method according to claim 49, wherein at least one of the following provisos are satisfied:
the external representation is established to be independent of one or more memory locations, the one or more memory locations corresponding to the first internal representation;
the establishing of the external representation comprises a plurality of identifying frames, the plurality of identifying frames comprising one or more inline frames of the web page; and
the establishing of the external representation comprises establishing a frame association representation.

53. The method according to claim 49, wherein at least one of the following provisos are satisfied:
an external frame representation is established for each of two or more frames, at least one of the two or more frames comprising at least one inline frame of the web page;
the external representation is established by serializing at least a part of the content of an Internal Document Object Model; and
the external representation is established based on an Internal Document Object Model representation of the web page in the web browser.

54. The method according to claim 49, wherein at least one of the following provisos are satisfied:
the first content of the first internal browser state representation comprises markup content, and wherein the external representation comprises a representation of the markup content;
the first content of the internal browser state representation comprises a representation of style sheet content, and wherein the external representation comprises a representation of the style sheet content;
the first content comprises cookie data related to the first internal browser state representation, and wherein the external representation comprises a representation of the cookie data; and
the first content comprises form content of the first internal browser state representation, and wherein the external representation comprises a representation of the form content.

55. The method according to claim 49, wherein the establishing of the mapping data comprises:
processing the first internal representation;
identifying one or more pointers between Objects of the first internal representation based at least in part on the processing; and
mapping the pointers to memory addresses of the objects; and
wherein at least one of the following provisos are satisfied:
the mapping data comprises mapping of one or more relations between the dynamic content and markup content of the first internal browser state representation;
the mapping data comprises mapping of pointers between the dynamic content and style sheet content of the first internal browser state representation; and
the mapping data comprises mapping one or more pointers to one or more memory addresses of one or more objects of the first internal browser state representation.

56. The method according to claim 49, wherein a least one of the following provisos are satisfied:
the establishing of the external representation comprises converting the first content into one or more converted formats, each of the one or more converted formats being different from a format of the internal browser state representation;
the establishing of the external representation comprises converting at least a part of the first internal browser state representation into an external representation of an Internal Document Object Model of the first internal representation;
the establishing of the external representation comprises converting a plurality of Internal Document Object Models of different frames of the first internal browser state representation into one or more external representations of the plurality of Internal Document Object Models; and
the first internal browser state representation comprises at least one of markup content and style information, and wherein:
if the first internal browser state representation comprises the markup content then the converting comprises formatting at least some of the markup content into a markup Language format; else
if the first internal browser state representation comprises the style information, the converting comprises formatting at least some of the style information into a cascading style sheet format.

57. The method according to claim 49, wherein the first internal browser state representation comprises a plurality of different content elements, each different content element comprising at least a portion of one or more of:
the first content; and
the dynamic content;
wherein the establishing of the external representation further comprises establishing a plurality of individual representations, each individual representation being based on the first internal browser state representation; and
wherein each individual representation corresponds to at least one of the plurality of different content elements.

58. The method according to claim 49, herein at least one of the following provisos are satisfied:
the establishment of the further internal representation comprises mapping at least one connection between a representation of browser markup language content and dynamic content in the web browser application, wherein the mapping is based at least in part on the mapping data; and
the establishing the further internal representation comprises establishing one or more pointers between one or more objects of the further internal representation, wherein the establishing is based at least in part on the mapping data.

59. The method according to claim 49, wherein each of the first internal representation and the further internal representation are incorporated in one or more of:
at least one web browser;
at least one web browser application;
at least one web page; and
wherein the first internal representation and the further internal representation are incorporated in either or both of:
a different one of the one or more web browser(s), web browser application(m)and web page(s); and
a different type of the one or more web browser(s), web browser application(s) and web page(s).

60. The method according to claim 49, further comprising establishing a plurality of further internal representations in a plurality of web browser applications, wherein each of the plurality of web browser applications in which the further internal representation(s) is/are established is different from every other of the web browser applications in which the further internal representation(s) is/are established.

61. The method according to claim 49, wherein the web page processing of the web page comprises processing the dynamic content of the web page during a browsing operation, the browsing operation operating on the web page.

62. The method according to claim 49, wherein the dynamic content of the web page includes scripts of the web page.

63. The method according to claim 49, wherein the web browser comprising the first internal representation externalizes the first internal browser state representation into the external representation, based at least in part on serializing at least a portion of the first internal representation.

64. The method according to claim 49, wherein the web browser application for the further internal representation establishes the further internal representation, based at least in part on deserializing at least a portion of the external representation.

65. The method according to claim 49, further comprising, using a web robot:
determining whether one or more predefined criteria are satisfied;
initiating the establishing the external representation based at least in part on determining one or more of the predefined criteria are satisfied; and
wherein the web robot is configured for establishing one or more further internal representations based on an external representation.

66. A system for establishing external representations of a first internal browser state representation of a web browser and establishing a further internal representation based thereon, the system comprising a processor and logic integrated with and/or executable by the processor, the logic comprising:
web browser logic configured to use the processor to externalize the first internal browser state representation into an external representation of the state, wherein externalizing the first internal browser state into the external representation of the state comprises:
establishing a representation of a first content of the first internal browser state representation;
establishing, using the processor, a dynamic content state representation which represents the state of the dynamic content of the first internal browser state representation; and
establishing, using the processor, mapping data comprising mapping of relationships between the dynamic content and the first content of the first internal browser state representation, and
wherein a web browser application is configured for establishing the further internal state representation based on the external state representation at a browser state corresponding to the state of the first internal browser state representation.

67. The system according to claim 66, wherein the web browser logic is further configured to:
process, using the processor, a pre-established external browser state representation,
parse, using the processor, a result of the processing into an internal Document Object Model of the web browser application;
process, using the processor, mapping data of the pre-established external browser state representation; and
implement, based on the mapping data and using the processor, one or more relationships between dynamic content and first content represented in the internal Document Object Model.

68. The system according to claim 66, comprising web robot logic configured to browse one or more web pages using the web browser logic, wherein the web robot logic operates according to a predefined set of rules so as to process the one or more web pages; and
wherein the web robot logic is configured to initiate establishment of one or more external representations in response to determining one or more predefined criteria are satisfied.
